(19) United States
(12) Patent Application Publication
(10) Pub. No.: US 2019/0187856 A1
(43) Pub. Date: Jun. 20, 2019

(54) TOUCH AND STYLUS SENSING

(71) Applicant: AZOTEQ (PTY) LTD, Paarl (ZA)

(72) Inventors: Frederick Johannes BRUWER, Paarl (ZA); Tobias Gerhardus BRAND, Paarl (ZA); Jacobus Daniel VAN WYK, Paarl (ZA)

(21) Appl. No.: 16/220,124

(22) Filed: Dec. 14, 2018

(30) Foreign Application Priority Data
Dec. 15, 2017 (ZA) 2017/08524
May 31, 2018 (ZA) 2018/03620

(51) Int. Cl. G06F 3/041; G06F 3/044; G06F 3/046; G06F 3/0354; G06F 3/038; G06F 3/0488; G06F 3/14

(52) U.S. Cl. CPC G06F 3/0416; G06F 3/044; G06F 3/046; G06F 3/03545; G06F 3/03547; G06F 2203/04104; G06F 3/04883; G06F 3/1423; G06F 2203/04108; G06F 2203/04106; G06F 3/038

(57) ABSTRACT

A trackpad for a dual user interface has capacitive sensing and inductive sensing capabilities, charge transfer measurement circuitry, a set of a plurality of sensing electrode structures, a set of a plurality of inductive receiving coils and at least one inductive transmit coil. The set of sensing electrode structures is used with the charge transfer measurement circuitry for capacitive sensing and the capacitive sensing is used to discern user input via finger proximity or touch. The set of inductive receiving coils is used with the charge transfer measurement circuitry for inductive sensing and the inductive sensing is used to discern user input via a stylus.

### CROSS-REFERENCE TO RELATED APPLICATION

The present application claims priority from South Africa application ZA 2017/08524, filed on Dec. 15, 2017, and South Africa application ZA 2018/03620, filed on May 31, 2018, the contents of which are hereby incorporated by reference into this application.

### BACKGROUND OF THE INVENTION

Inductive sensing buttons which utilize conductive or magnetic material to influence the inductance of a measured structure are known in the art. For example, in U.S. Pat. No. 8,847,892 laminar structures which use either a bulk conductor or magnetic material being pushed closer to a sensing coil are disclosed. In US 2011/0187284 inductive sensing buttons with a metal target located below an outer surface are taught, wherein the outer surface is depressed by a user, causing the metal target to be pushed towards a sensing coil.

When a metal target is pressed closer to an inductive coil structure, the inductance of the structure typically decreases due to eddy current losses in said metal. Conversely, when the target is fashioned out of a material with high magnetic permeability, the inductance for said coil structure typically increases due to lower reluctance in the magnetic field path.

The art may benefit from user interface structures, for example push buttons, which make use of both the decrease in measured inductance when a conductive target is proximate to a coil structure and the increase in measured inductance when a magnetic material target is proximate to said structure.

It may be more difficult to cause an accidental state change for inductive sensing buttons or switches, or to tamper with such buttons or switches, than for Hall-sensor & magnet based buttons or switches. The latter may change states, intentionally or unintentionally, when a strong magnet moves close enough to the button or switch to cause the field of said strong magnet to swamp or dominate the magnetic field of said button or switch's own magnet. In safety or critical applications, such an unintended state change may have catastrophic consequences. For inductive sensing buttons or switches, the effects of engaging metal or magnetic material members are typically much more localised, requiring said members to move very close to sensing coils or inductive structures before a state change is effected, possibly making inductive sensing buttons or switches more safe and reliable by default.

### SUMMARY OF THE INVENTION

The present invention teaches a user interface device with an inductive coil structure of which the inductance is measured, wherein a user may simultaneously manipulate a conductive member and a magnetic member with high relative magnetic permeability, wherein said manipulation may cause the magnetic member to move closer to the coil structure while simultaneously causing said conductive member to move further from the coil structure, or vice versa. An inductance measurement circuit, or another circuit, may measure the change in inductance, or another parameter, due to said manipulation and said movement of the conductive member and the magnetic member. The resulting measurement data may be used to discern user input or commands for an electronic system. For example, a charge transfer based inductance measurement circuit may be used to measure said change in inductance.

In a first embodiment of the present invention, a push button structure may be realized as follows. A conductive dome structure may be located over a coil structure. The conductive dome structure may have a number of slits cut into its apex. When the apex is pressed downwards, an opening in the dome structure is formed due to said slits. A magnetic member, for example a ferrite member, may be located above the dome structure, and aligned with the centre of said apex. Said magnetic member may be resiliently supported and held in place by a flexible member. When a user applies less than a specific amount of force to the magnetic member or to the flexible member in a downwards direction, said magnetic member may move slightly and apply a finite amount of pressure on said dome apex. However, if a user applies more than a specific amount of force to said magnetic or flexible members, the flexible member may suddenly deflect downwards, also known as snapping through. This may result in the magnetic member pressing with sufficient force on said apex and slits to cause an opening to form in the dome apex, wherein said magnetic member may protrude through said opening. In other words, when said flexible member snaps through, the magnetic member may suddenly move through the opening in said dome apex, and may come close to said coil structure. Therefore, the snap through action of the flexible member and/or said dome structure, due to more than said specific amount of force applied to said push button structure, may be discerned from measured inductance values of the coil structure. For example, a charge transfer based inductance measurement circuit may be used to monitor the inductance of the coil structure. When less than said specific amount of force is applied to the push button structure, said dome structure remains more or less closed, and may cause significant eddy current losses, reducing said coil structure inductance. When more than said specific amount of force or pressure is applied to the push button structure causing the flexible member to snap through, and said magnetic member to move closer to the coil structure through an opening in said dome, the measured inductance may increase suddenly due to a reduced magnetic field path reluctance, allowing detection of the snap through event with a large signal to noise ratio. The large ratio may be due to said coil structure being loaded with eddy currents in a first state of said push button, and having a magnetic member in proximity in a second state of said button.

To ensure that said slits do not negatively affect the amount of eddy-currents, and said signal to noise ratio, the frequency of the signal used to energize said coil structure may need to be optimized relative to required slit length.

In the preceding, and elsewhere in the present disclosure, conductive members and magnetic members may be interchanged without departing from the underlying concept of the present invention. In other words, in the above push button, the first state may be characterised by proximity of magnetic material to the coil structure, and a high measured inductance value, and said second state may be characterised by proximity of conductive material to the coil structure, and reduced inductance due to eddy current losses.

In a second push button embodiment of the present invention, a flat member fashioned from metal, or another conductive substance, is suspended between two supports. A plurality of slits exists centrally in the surface of said member, allowing an opening to form when the member is pressed at its centre in a direction substantially orthogonal to said surface. A flexible member is attached to said supports in such a manner that it covers said flat member, and is arched away from the flat member. A magnetic member with high relative magnetic permeability may be attached to the apex of said arch. When a user presses the flexible member with sufficient force towards the flat member, said flexible member may suddenly give way, i.e. it may snap through, providing tactile feedback to the user. When the flexible member snaps through, said magnetic member may press onto said flat member, causing an opening to form centrally in the surface of said flat member, due to said slits. This opening may allow the magnetic field of a coil structure, located underneath said flat member, to couple with said magnetic member, causing a discernible increase in the measured inductance of the coil structure. When the magnetic member does not press onto said flat metal member with sufficient force to cause said opening to form, the flat member may cause substantial eddy current losses for said coil structure, decreasing the measured inductance.

In another embodiment of the present invention, a single, centrally located lengthwise slit may be used in the flexible member, with said flexible member being conductive, for example. If the flexible member is pressed with a first amount of force in a direction orthogonal to the surface of the member, the slit may widen to form an opening, which may be used to couple magnetic field from an associated coil through a proximate magnetic member, similar to what is described above. An inductance measurement circuit may be used to detect a consequent increase in inductance, and annunciate a first button event. When said flexible member is pressed with a second amount of force in a direction orthogonal to the surface of the member, wherein said second amount of force is sufficient to cause the flexible member to snap through, the lengthwise slit may resume its original width, i.e. it may close again, causing a sudden measurable decrease in inductance, which may be used to annunciate a second button event.

A fourth embodiment of the present invention may be found in a inductive sensing push button structure which utilize a rotating member to cause inductance of an associated coil to decrease or increase measurably, allowing detection of pushbutton activation. Said rotating member may comprise two sections, with a first section consisting of, or having a surface of conductive material, for example copper or aluminium. The second section of said rotating member may comprise a magnetic material with high relative magnetic permeability. The rotating member may be located above a coil or inductive structure of which the inductance is measured, with the axis of rotation located over the centre of said coil or inductive structure, and orthogonal to its magnetic axis. In nominal position, that is when said push button structure is not pressed, either the first or second section of the rotating member may be located such that it is aligned with said magnetic axis. An arching flexible structure, for example a plastic or metal dome structure, may be located above said rotating member and coil, with a pin or another structure fixed to the apex of said flexible structure. When a user applies sufficient force to the flexible member to snap through, said pin may engage the rotating member, causing it to rotate so that the other of said first or second section is aligned with the magnetic axis of the coil or inductive structure. Therefore, when the push button structure is not pressed sufficiently to cause snap through, the inductance of said coil may be at a first value, for example at a low value due to eddy current losses caused by said first section of the rotating member. When the push button structure is pressed sufficiently to cause snap through, the measured coil inductance value may be at a second value, for example at a high value due to said second, magnetic section of the rotating member being aligned with said magnetic axis.

The present invention also includes a fifth exemplary inductive push button embodiment which makes use of two rotating members. In a preferred, but not limiting, embodiment, both rotating members comprise conductive material, either being fully fashioned out of conductive material, or having some or all outer surfaces covered with conductive material. The rotating members are mounted parallel to each other so that, in an unactuated state, two of the member's lengthwise edges are coincident or nearly coincident. Flexible members, for example rubber bands or plastic or metal springs, may be used to return the rotating members to the position where said edges are coincident or nearly coincident. The two rotating members may be mounted within, for example, a circular support structure. A substrate may be located below the circular support structure, with a coil or inductive structure on one or the other side, or both sides, of said substrate such that the magnetic axis of the coil coincides with the centre of the circular support structure and is also orthogonal to the axes of rotation of said rotating members. When the two rotating members are in the unactuated state or position, the inductance of said coil or inductive structure may be at a low value, due to eddy current losses in the conductive material of the rotating members. Above the two rotating members, a dome structure may be mounted onto the circular support structure, with a magnetic member with high relative magnetic permeability attached to or located at or near the apex of said dome structure. When a user actuates the push button by pressing the dome with sufficient force to cause it to snap through, said magnetic member may engage said rotating members in such a manner that they rotate, allowing the magnetic member to pass between them and move substantially closer to said coil or inductive structure. This may cause a measurable increase in the inductance of the coil or inductive structure that may be used to detect and annunciate actuation of the push button.

In yet another embodiment of the present invention, an actuation arm presses onto a rotating member when a push button structure, or another user interface structure or device, which contain said arm and rotating member, is depressed. Said rotating member may comprise out of a conductive section and a magnetic section, wherein the latter have high relative magnetic permeability. The rotating member may have a unique shape, which may be used to cause said conductive section to move closer to an associated coil, or other inductive structure, when a first amount of pressure or force is applied to said push button structure, thereby causing increased eddy current losses for said coil, and a corresponding decrease in measured inductance. When a second amount of force or pressure, larger than said first amount of force or pressure, is applied to said push button structure, the rotating member may rotate such that said magnetic section moves closer to said coil, and said conductive section moves away from said coil. This may cause an increase in the measured inductance for said coil, which may be due to less reluctance in the magnetic field path of the coil. According to the present invention, the state or status of said push button, or another user interface structure, may be discerned from the measured inductance value of the coil.

The present invention further teaches that latching mechanisms similar to those used in prior art push buttons, and other user interface and electronic devices, may be used with the push buttons and user interface structures disclosed herein to provide latching functionality.

Further, the latching mechanism found in typical “click” or retractable pens may also be used to realise an inductive sensing based push button structure, according to the present invention. Such latching mechanisms are often characterised by the fact that they do not only extend or retract a pen tip, but also rotate said pen tip by typically ninety degrees when the pen is pressed to change state from extended to retracted or vice versa. The present invention teaches that the rotation of such a prior art click pen latching mechanism may be used in push button to selectively place either conductive or magnetic material over a coil of which the inductance is measured, thereby allowing a circuit to determine the state of said click pen mechanism and correspondingly of said push button.

Therefore, in a general sense, the present invention may be embodied in an inductive sensing based push button structure that comprises a conductive member or members located over a coil or inductive structure, wherein, in an unactuated push button state, said conductive member or members cause eddy current losses and a resultant decrease in the measured inductance of said coil or inductive structure, and wherein application of more than a specific minimum amount of force or pressure to the push button structure by a user cause a flexible and/or resilient member to snap through and said push button structure to enter an actuated state, and an opening to form within said conductive member or members, or between or proximate to said conductive member or members, with a magnetic member with high relative magnetic permeability suddenly moving in such a manner as to facilitate improved coupling of the magnetic field of said coil or inductive structure through said opening with said magnetic member, or with the magnetic member not moving, but said opening merely facilitating said improved coupling, leading to a reduced magnetic field path reluctance and an increase in measured coil or inductive structure inductance, from which said push button actuated state may be discerned. It is to be appreciated that in the directly preceding, and elsewhere in the present disclosure, the conductive and magnetic members may be interchangeable, with, for example, the unactuated push button state characterised by a higher measured inductance due to coupling with the magnetic member, and the actuated push button state characterised by a lower measured inductance, the latter due to increased eddy current losses.

The present invention may also be embodied in inductive sensing based buttons or switches, or other structures, which make use of either only conductive members or of only magnetic members to cause a state change in said buttons or switches. In other words, according to the present invention, embodiments such as those disclosed may use, for example, only a conductive member to change the inductance of a measured coil or structure, or coils or structures, when a user presses or otherwise engage the switch or button structure, and wherein said change in measured inductance may be used to decide whether said switch or button has been activated or deactivated. Conversely, embodiments such as those disclosed may use only a magnetic member to change the inductance of said measured coil or structure, or coils or structures, when a user presses or otherwise engage the switch or button structure, with said change in measured inductance which may be used to determine the actuation state of said switch or button.

In another exemplary embodiment, a switch or button structure using differential inductance measurements may be realized. In such an embodiment, two inductive sensors or coils, or other structures, may be used, wherein the inductance of the two coils may be measured, for example with a charge transfer based measurement circuit, to discern switch or button state. During a button or switch state change, the first coil may experience a change in measured inductance in a first direction, whereas the second coil may experience a change in measured inductance in a second opposite direction. In other words, when a user presses or engages the switch or button structure to cause a state change, said first coil may, for example, experience a decrease in its measured inductance, whereas said second coil may correspondingly experience an increase in its measured inductance. Such differential inductance measurements may reduce the effort required to determine button or switch state at power-up or start-up.

For example, it is envisaged that a differential inductance measurement based button or switch may make use of a conductive member to cause a change in the inductance of said first coil during button or switch state change, while the inductance of said second coil is substantially not influenced by any moving member during said state change. As a result, when the button or switch state change cause the conductive member to move closer to said first coil, for example, the measured inductance of the first coil should decrease due to eddy current loading, while the measured inductance of said second coil should stay substantially the same, barring changes due to temperature and such, which may also influence the first coil correspondingly.

Alternatively, according to the present invention, a differential inductance measurement based button or switch may utilize a conductive member to cause a change in the inductance of said first coil during button or switch state change and a magnetic (e.g. ferrite) member to cause a change in the inductance of said second coil during said state change. Correspondingly, when the button or state change cause said conductive member to move closer to the first coil, for example, and cause a decrease in first coil inductance, said magnetic member may also move closer to said second coil, thereby causing an increase in the measured second coil inductance. Conversely, when the conductive member moves further away from the first coil due to switch or button state change, resulting in an increase in the measured first coil inductance value, said magnetic member may also move further away from the second coil, causing a decrease in the inductance measured for said second coil.

In a third exemplary alternative, a differential inductance measurement based button or switch may be realized where a magnetic member is used to cause a change in the inductance of said first coil during button or switch state change, whereas the inductance of the second coil is substantially not influenced by any moving member during said state change. As a result, when a user engages the button or switch structure to cause a state change, and said magnetic member moves closer to said first coil, for example, the measured inductance for the first coil may increase, while the measured inductance value of said second coil may stay substantially unchanged. Conversely, when the state change causes the magnetic member to move away from the first coil, measured first coil inductance may decrease, while the measured inductance of said second coil may stay substantially unchanged.

In another exemplary embodiment of the present invention, the inductor or inductive structure being measured or monitored to determine button or switch actuation state may be realized within the packaging of an integrated circuit (IC), wherein the IC may or may not comprise charge transfer measurement circuitry, or other circuitry, used to perform the inductance measurements. In a preferred embodiment, the inductance is realized on silicon within the IC. Said IC may also contain circuitry used to discern and annunciate switch or button activation.

According to the present invention, for such an inductive measurement IC with the inductor integrated into the IC, or for other embodiments where the measured inductor is external to said IC, a push-button may be realized using a transparent conductive layer located on the glass of a mobile electronic device's screen, for example, but not limited to, the Indium Tin Oxide (ITO) layer on the glass display of a smart phone. When a user presses down on said glass, the ITO layer may move closer to the inductor within said measurement IC, which may cause an increase in the eddy current loading of said inductor, wherein said increase may result in a measurable decrease in the inductance of said inductor, allowing detection of the user press event.

To ease manufacturing constraints, the present invention teaches that pliant or flexible material may be used between a moving member and a conductive or magnetic member, wherein said conductive or magnetic member's relative position to a coil or inductive structure, for example a coil within a charge transfer measurement based inductive sensing IC, is used to measurably influence the inductance of said coil or inductive structure. When said moving member moves a first distance towards the coil, the conductive member (or alternatively the magnetic member) may correspondingly also move said first distance, or a distance related to said first distance, towards the coil and may then be pressed against the coil, or against a layer or layers covering said coil, with mechanical constraints which may prevent said conductive member (or alternatively the magnetic member) from moving closer to the coil. When said moving member moves more than said first distance towards the coil, the conductive member (or alternatively the magnetic member) may remain in the same position, which is pressed against said coil, or against a layer or layers covering the coil, while the pliant or flexible material may compress increasingly as the moving member moves closer to the coil. In other words, movement of the moving member towards said coil need not be constrained to only said first distance, and it may move across larger distances while the conductive member (or alternatively a magnetic member) remains substantially in the same position relative to the coil, thereby resulting in substantially the same inductance value measured for said coil as when the moving member moves said first distance to said coil. The pliant or flexible material may be rubber, a type of sponge, a metal spring, a plastic spring and so forth. Not requiring said moving member to move exactly and only for said first distance may ease manufacturing constraints. The moving member may be part of a push-button switch, of a latching toggle switch, of a door or window open/close detection unit or any other suitable application. Naturally, the coil in the directly preceding embodiment need not be integrated into an IC, but may also be any external coil or inductive structure.

In yet another exemplary embodiment, a latching toggle switch which utilizes differential inductance measurements, and similar in mechanical structure to the ubiquitous wall light switches, may be realized. For example, such a switch may comprise two coils or inductive structures, with a charge transfer measurement circuit which may be used to measure their inductance, wherein said coils or inductive structures may be located near the two lengthwise ends of the switch. First and second metal members may be positioned within a moving part of said switch such that switch actuation, and an associated pivoting action of the switch, cause said first metal member to move closer to a first of the two coils, while said second metal member correspondingly moves away from a second of said two coils, or vice versa. As a result, the measured inductance of the first coil may decrease while that of the second coil increases, or vice versa. Switch activation or deactivation may be determined from the differential inductance measurements. The switch may be fashioned as a module which can be clipped into or onto a sealed surface, with said two coils or inductive structures located beneath said surface. Clip or retaining structures within or on said sealed surface may be used to align said module with the coils. Advantageously, an embodiment as described may allow quick and easy replacement of the part of a switch assembly most prone to failure, i.e. the part with moving members. A standard latching mechanism as used in wall light switches, or another latching mechanism, may be used with the present embodiment to latch the switch into a particular state.

In yet another embodiment of the present invention, a user interface device with a passive stylus or pen having a tip comprising a magnetic member or a metal member, and wherein said stylus tip may be used to influence the coupling between at least one transmitting inductor or coil and at least one receiving inductor or coil, thereby entering or selecting specific coordinates in an associated display or another area, is taught. In a preferred embodiment, the at least one transmitting inductor or coil may be driven in a resonant manner, that is it resonates with a first capacitor at a specific first frequency, and the drive signal is applied at the first frequency, and the at least one receiving inductor or coil may be connected to a second capacitor, wherein said receiving inductor or coil and second capacitor may also resonate at said first frequency. However, the embodiment is not limited to the use of resonant pairs only.

Preferably, the at least one transmitting coil or inductor may surround a plurality of receiving inductors or coils, wherein said receiving inductors or coils may be arranged in an inter-leaved pattern. For example, each receiving coil may overlap with at least two of its neighbouring coils. Naturally, each receiving coil would typically be isolated from the other receiving coils. For example, in a printed circuit board embodiment, the coils may be located on different layers. The at least one transmitting coil and the at least one receiving coil may be arranged along one dimension, in two dimensional array or in a three dimensional array. In a preferred application, a single transmitting coil or inductor may surround a plurality of receiving coils or inductors, wherein the receiving coils or inductors may be arranged along X and Y axes, and may be orthogonal to each other.

The at least one receiving coil or inductor may be monitored or measured with a charge transfer based measurement circuit, as an example. According to the present invention, a magnetic member located in the tip of said stylus may be manufactured from specific material and dimensioned such that it not only increases the coupling of a specific first receiving coil with said transmitting coil when the stylus tip is located over said first receiving coil, but also decrease the coupling between said transmitting coil and other receiving coils in the vicinity of the first receiving coil. In this manner, the signal-to-noise ratio of the signal used to determine stylus location or coordinates may be significantly increased. According to the present invention, distances between respective receiver coils, and between receiver coils and the at least one transmitter coil, may influence the operation of the above embodiment, and may need to be designed accordingly.

The present invention includes sensing or detection of the amount of pressure applied by said stylus to the surface containing said at least one transmitter and at least one receiver coils. The amount of pressure may be detected by circuitry within the stylus itself, or it may be detected via structures and circuitry in said surface. For example, the amount of relative or absolute movement of the whole surface, or a subsection of it, may be measured with capacitive or inductive sensors using a charge transfer based measurement circuit. Other methods and apparatus to measure the amount of movement of said surface, or a subsection thereof, may also be used.

In yet another exemplary embodiment, the stylus of a user interface device or system, wherein said stylus may be passive or active, as is known in the art, has a unique form to ensure that the tip of the stylus is substantially orthogonal to the sensing surface used to detect said stylus when the stylus body is held at an angle to said surface, for example being held by a user in a normal writing or drawing grip. In other words, a stylus of the present invention may be fashioned such that its tip may be orthogonal or close to orthogonal to an associated sensing surface when a user grips it in a normal manner as used for writing or drawing, with the body of said stylus being at an angle to said surface. The may assist in preventing or overcoming the so-called hand shadow effect experienced with prior art styli held at an angle. Further, the present invention teaches that the stylus may comprise a user-adjustable swivel joint, which may be used to change the angle between the body and tip of said angle to fit the grip or writing style of an individual.

In the preceding, and elsewhere in the present disclosure, it should be appreciated that wherever reference is made to an inductance, either the self-inductance of a coil or structure, or the mutual inductance between two coupled coils or structures may be used to practise the teachings of the present invention.

In an alternative stylus embodiment, a passive stylus may comprise a ferrite point, or a point fashioned from other magnetic or conductive material, which may move relative to the stylus body. For example, the point may move into and out of the stylus body, and may be resiliently supported. When a user applies pressure to said point by pressing the stylus against a surface such as a tablet or pad containing the above disclosed transmitting and receiving coils or inductive structures, the point may move accordingly into the stylus body. Once the pressure is removed, said point may be returned to a maximally extended position by a resilient member such as a spring.

According to the present invention, movement of the ferrite member or point may be detected by using a coil which is placed around said point, and wherein this point-coil may be selectively short-circuited. When the point-coil ends are connected in a short-circuit, coupling of magnetic flux from a transmitter coil to a particular receiver coil in proximity to said ferrite point or member may be adversely affected. If the short-circuit is suddenly opened, for example by using switching means, coupling between the transmitter coil and the receiver coil may rapidly improve. According to the present invention, said switching means may be coupled to the ferrite point of the stylus in such a manner that movement of the ferrite point or member in a particular direction may cause the switching means to change state. For example, when said stylus point is not pressed against the surface of said tablet or pad, i.e. the point is in a maximally extended state, the switching means may be in a closed state, with said point-coil short-circuited. This may cause decreased coupling between the transmitter coil and a particular receiver coil in proximity to the stylus point. Once the stylus point is pressed with sufficient force against the surface of said tablet or pad, the switching means may change state to become open circuit, removing said short circuit across the point-coil, which may allow the ferrite point to improve coupling between the transmitter coil and a particular receiver coil in close proximity to said point. In an exemplary embodiment, a charge transfer based measurement system may be used to monitor the coupling between said transmitter coil and the associated receiver coils. When the point-coil around the ferrite point or member is short-circuited, i.e. the stylus is not pressed against the tablet or pad surface, charge-transfer counts should be at a relatively high value. Once the stylus point is pressed with sufficient force or pressure against the surface to cause said short-circuit to be removed, the counts should decrease accordingly to a relatively low value. This may be used to identify the position of the stylus point on said tablet or pad.

In a related exemplary embodiment of the present invention, additional switching means may be connected in parallel to the first switching means across said point-coil. In other words, the point coil may be selectively short-circuited via either first or second switching means, wherein the first switching means is operated by movement of said ferrite point, as disclosed above. Said second switching means may comprise a push-button or other structure located on or in the stylus body such that a user may easily engage it to cause a state change. The first and second switching means may differ in their resting state, wherein the first switching means is configured to be Normally-Closed and the second switching means is configured to be Normally-Open. As such, when said stylus is not pressed against a surface, the first switching means may be in a closed state, thereby short-circuiting the coil around said ferrite point or member. Conversely, when the second switching means is not pressed by a user, it may be in an open state. Therefore, when the stylus is pressed with sufficient force against the tablet or pad surface to cause the first switching means to be open-circuit, and said second switching means is not pressed, said point-coil may be open circuit, which may result in improved coupling between a proximate transmitter and receiver coil or inductance. When a user presses or otherwise engages the second switching means, said point-coil may be short-circuited again which may cause a measurable decrease in coupling between a transmitter and receiver inductance. For example, user press of the second switching means may be used to emulate a tap gesture with said stylus, or to perform selection of presented digital content, or to confirm a selection with said stylus and so forth. The present invention is not limited in this regard.

The present invention further teaches that said second switching means may be used to connect a specific resistance value across the terminals of the point-coil. This may be used to discern a specific command or instruction by the user, distinct from the two states where said point-coil is either open-circuit or short-circuited. That is, connection of a specific resistance value across said point-coil may result in a measurable value of coupling between a transmitter coil and a receiver coil which is distinct form the values measured when the point-coil is open-circuit or short-circuited.

In addition, it may be possible to use a point-coil similar to that described above with a range of resistance values to determine the amount of pressure applied to the stylus point. For example, a structure may be realized which is mechanically coupled to the ferrite point of the passive stylus, wherein the structure comprises a spring loaded contact which may engage a resistor or a printed circuit board (PCB) containing a number of resistances. The resistor or PCB may be mechanically fixed to the stylus body. Therefore, when the stylus point is pressed to move into the stylus body, said contact should move accordingly, and sweep across the resistor or PCB fixed to the stylus body. The resulting variable resistance may be connected across the terminals of said point-coil, and may be used to discern the amount of pressure applied to the stylus. That is, when said passive stylus is pressed with more or less pressure or force against the surface of a tablet or pad which comprises associated transmitter and receiver inductances, the resulting change in resistance placed across the point-coil, due to movement of said contact, may be used to cause a change in coupling between the transmitter and receiver inductances, which may allow the amount of pressured applied to be determined.

Further, the sweeping contact structure may also include a zero or near-zero resistance, which may be used to short-circuit said point coil when the stylus is not pressed with sufficient force or pressure against a surface. Thus, a passive stylus with a ferrite point and point-coil as disclosed may be inventively used to detect when and where a user presses the stylus against an associated tablet or pad surface, and also the amount of pressure or force used once more than a predetermined first amount of pressure or force is applied.

An alternative, exemplary embodiment of the present invention as follows may also be used to detect the relative amount of pressure or force applied with a passive stylus once it increase to more than predetermined minimum. A point-coil may be wound around the ferrite point member of a stylus. (Said point member may also be fashioned out of other magnetic materials.) The point member may move into and out of the stylus body, with said point-coil selectively short-circuited with switching means dependent on the amount of pressure/force applied, as described earlier during the present disclosure. In other words, when no pressure is applied to the stylus point member, the point-coil may be short-circuited. Once a sufficient amount of pressure is applied, for example by pressing the stylus point member against a tablet or pad surface, the stylus point member may move accordingly into the body of said stylus, causing said short-circuit across the point-coil to be removed, wherein said removal may be discerned from inductance measurements of associated transmitter and receiver, or other, coils. In addition, the present invention teaches that a magnetic-flux altering member may be located at the distal end of said stylus point member, i.e. at the end of the stylus point member not protruding from the stylus housing. Said flux altering member may be fixedly mounted within the stylus body, and may comprise either magnetic material, for example ferrite, or conductive material. When the stylus is not pressed against any surface, i.e. said point-coil is short-circuited, the flux altering member may be located a first distance from said distal end of the stylus point member. Once more than a minimum amount of force is applied to the stylus and the point member moves into the stylus body, said short-circuit may be removed, with the distance between the distal end of the point member and the flux altering member decreasing accordingly. According to the present invention, the influence of the flux altering member on the flux protruding from the ferrite point member should vary as said distance is decreased, and this variation may be used to discern the amount of pressure applied by the stylus to a surface. For example, if said flux altering member is fashioned out of a conductive material, increased eddy currents may flow in it as the ferrite point member moves closer. The increase in eddy current loading may be discerned from inductance measurements of an associated receiver coil, or another coil, which may be used to determine the relative amount of pressure applied by the stylus to a surface.

As described earlier in the present disclosure, a resonant transmitter coil or coils may be used together with a plurality of resonant receiver coils to detect the position of a passive stylus which comprise a magnetic member point, for example a ferrite point, with each coil connected to a resonant capacitor, said capacitor chosen to achieve a theoretical first resonant frequency. However, it has been observed in practice that for the usage case where all coils are allowed to resonate simultaneously, i.e. all coils have their capacitors connected and the transmitter coil is driven at said first resonant frequency, resonances at multiple frequencies occur, which may significantly increase the amount of effort required to translate receiver inductance measurements into stylus position. The present inventors have found that by lowering the frequency of the drive signal connected to the transmitter coil or coils to slightly below the theoretical first resonant frequency, a stable situation results, where the position of a ferrite tipped passive stylus may be discerned without undue effort. To clarify, the present invention teaches use of a single or a plurality of transmitter coils, with each transmitter coil connected to a resonant capacitor calculated to result in a first theoretical resonant frequency, and use of a plurality of receiver coils coupled to said transmitter coil or coils to detect the position of a passive, ferrite tipped stylus, wherein each receiver coil is connected to a resonant capacitor calculated to result in said first resonant frequency, but wherein said transmitter coil or coils is driven at a frequency somewhat lower or higher than said first resonant frequency, thereby reducing the detrimental impact of multiple resonant points while still utilizing increased gain. This may allow accurate stylus position detection while still utilizing energy storage in and exchange with said resonant capacitors to ensure sufficient signal to noise ratios.

According to the present invention, the selective short-circuiting of a coil wound around a magnetic member may also be advantageously applied to push-buttons. This may allow robust user interface buttons to be created cost-effectively across sealed surfaces. For example, a first coil may be placed on one side of a sealed surface which allow passage of magnetic fields at a first frequency. A magnetic member, for example a ferrite member, with a second coil wound around it, may be located at the other side of said sealed surface, and may couple or guide magnetic flux emanating from said first coil. The terminals of the second coil may be either connected together, i.e. short circuited, or open-circuit. When the terminals are open circuit, magnetic field from the first coil may couple with the magnetic member in such a manner that the amount of inductance measured for the first coil increases. However, when the terminals of the second coil are short-circuited, coupling of the magnetic field generated by said first coil with the magnetic member may be adversely affected, resulting in a decrease in measured inductance for said first coil. A dome structure may be placed over said magnetic member and second coil, and used to short-circuit the terminals of the second coil. For example, a conductive member may be attached to the apex of said dome structure in such a manner that it connects the two terminals of the second coil together when the dome is pressed with sufficient force to cause it to snap through. Thereby, the snap through event may be discerned as a sudden decrease in inductance of the first coil. As an alternative, said dome structure itself may be fashioned out of conductive material, and used to short-circuit said second coil terminals when the dome is pressed to snap through.

In another alternative push button embodiment, said conductive member attached to the apex of the dome structure and the terminals of said second coil is fashioned and arranged such that the terminals of the second coil is normally short-circuited, i.e. when the dome structure is not pressed. When a user applies pressure to the dome, it may deflect and cause the conductive member to move away from the terminals of said second coil, removing the short circuit, with a resultant increase in the measured inductance of the first coil which may be used to detect the dome press event.

In yet another related embodiment, a shaft which attaches said conductive member to the apex of the dome structure may be dimensioned and the terminals of said second coil located such that detection of a range of movement of said conductive member from an un-pressed state of the dome to a snapped-through state is possible. This may allow realization of a tri-state push button. In a first state, the button is not actuated, the second coil around said magnetic member is short-circuited by said conductive member, and the measured inductance of said first coil may be at a first value. During a second state, the user applies a first amount of pressure to said dome, causing it to deflect and the conductive member to move away from the terminals of the second coil, thereby removing said short-circuit, with the measured inductance of the first coil correspondingly changing to a second value. In a third state, the user may press the dome with sufficient force to cause it to snap through, resulting in said conductive member pressing against, or coming very close to, the one end of said magnetic member. This may result in significant eddy current loading of the first coil, and its measured inductance may decrease to a third value. By measuring the inductance of the first coil, said first, second and third states of the push button may be discerned from said first, second and third inductance values.

Another tri-state push-button structure may also be realized by practising the teachings of the present invention. A flexible dome structure may be located over a first coil or other inductive structure, with the coil located on one side of a sealed surface and the dome structure on the other. The inductance of said coil or inductive structure may be monitored with a charge transfer based measurement circuit, as an example. A magnetic member may be fixed to the underside of said dome, at its apex. A second coil may be fixedly located on said sealed surface underneath the dome structure, with the second coil initially being in open-circuit or unconnected state. When a user depresses said dome structure slightly, the magnetic member may move closer to said surface and the first coil, causing a first change in the measured inductance of said first coil. For example the inductance of the first coil may increase as said magnetic member moves closer to it. If more than a specific threshold of force or pressure is applied to said dome structure, it may snap through, with the magnetic member pressed against the surface. In this state, electrical contacts on said magnetic member, or on a substrate attached to it, for example a PCB, may connect the two ends of said second coil together, thereby short-circuiting the second coil. This may result in the measured inductance of said first coil suddenly changing due to the short-circuiting of the second coil, for example the inductance of the first coil may suddenly decrease substantially. In the described manner, a tri-state push-button may be realized, with a first unactuated state where inductance of said first coil is at a first value, a second pressed state, where said inductance is at a second, higher value, and a third snapped-through state where said inductance suddenly changes to a third value lower than the second value.

The present invention further teaches User Interface (UI) embodiments with a stylus. To determine stylus position in an associated, displayed document, the stylus may be used to touch a surface, wherein said surface may comprise means used to detect the position of said stylus. A first movement of the stylus after touching said surface may be used to drag a cursor to a correct position in said document. Hereafter, a double tap with said stylus on the surface, or alternatively a hard press with said stylus on the surface, may be used to lock said correct position.

A window may be displayed within said document, or elsewhere in the display, wherein said window represents the size of a trackpad used with said stylus to enter stylus position and movement. Movement of a cursor or another entity which represents the stylus in said document may be relative to the window. According to the present invention, three points of the window may be used to adjust window position and size. For example, two diagonal corners of the window may be used to adjust window size. A centre point of the window may be selected with said stylus and used to drag the whole window to a new position. The drag operation may be started by a double tap with the stylus on said centre point, which may allow a user to drag the window for predetermined period only. Alternatively, a double tap with the stylus may be used to signify the end of a drag operation to relocate said window.

Said window may also be repositioned by touching or tapping said trackpad with the stylus at its bottom, top, left or right peripheries. The stylus UI may apply a minimum movement filter before allowing said repositioning. For example, by touching or tapping the trackpad at its bottom edge or periphery with the stylus, said window may be moved downwards in the displayed document, Conversely, touching or tapping at its top edge may result in the window moving upwards. Left and right edge touches or taps with the stylus may result in movement of said displayed window to the left or right, respectively.

According to the present invention, when a stylus input system is combined with a traditional capacitive sensing touchpad used to sense the presence and movement of one or more fingers, an advantageous stylus UI may be realized. For example, a touch and/or another gesture or gestures by a finger or fingers may be used to locate the cursor in a displayed document, to locate said displayed window as discussed above, or to set the size of said window. The window may determine the relationship between movement of an associated stylus and movement of a cursor or another entity within the window or a displayed document. For example, the size of said displayed window may determine the size of displayed writing or drawings, wherein said writing or drawings may be entered with the stylus on a trackpad or other surface. If said stylus is based on the teachings of the present invention, changes in capacitance and inductance may be measured independently and simultaneously, wherein changes in capacitance may be used to track finger position and movement, and changes in inductance to track stylus position and movement.

In another stylus embodiment of the present invention, a stylus coil around a ferrite point member in a stylus is connected in parallel to a capacitor, and may resonate at a first resonant frequency. A short-circuiting element may be connected across the parallel stylus coil and capacitor pair, preventing resonance. Accordingly, when said stylus is in proximity to a surface which contains a number of transmitting coils, wherein current through said transmitting coil or coils varies or oscillates at said first resonant frequency, the stylus coil and capacitor should not resonate, and receiving coils and associated circuitry in said surface may not detect the presence, position and/or movement of the stylus. The receiving coils may be, e.g., connected to circuitry which utilizes a charge transfer based technique or method to monitor or measure the inductance of said coils. According to the present invention, when the point of said stylus is pressed against said surface, or another surface, a mechanism within the stylus may be used to remove the short-circuit across said stylus coil and capacitor resonant pair. This may result in the resonant pair being energised by magnetic fields emitted by said transmitting coil or coils, and the pair resonating at said first resonant frequency. Subsequently, the receiving coils and connected circuitry may be used to determine the presence, position and/or movement of the stylus, for example using a charge transfer measurement technique or method.

The present invention should not be limited to a stylus coil being wound around a ferrite or magnetic material point member in the directly preceding embodiment. For example, said point member mail also be manufactured out of plastic, or said stylus coil may be located apart from said point member.

In a related exemplary embodiment, a mechanism within the stylus may be used to either connect or disconnect the stylus coil and capacitor to/from each other, to allow or inhibit resonant current flow. For example, a stylus point member fashioned out of ferrite, or another magnetic material, may have a stylus coil wound on it. The stylus point member may also be fashioned out of a non-magnetic material, for example plastic. One end or terminal of said stylus coil may be connected to one end or terminal of a stylus capacitor, wherein the combination of said stylus coil and capacitor may have a first resonant frequency, as is known in the art. The other ends or terminals of said stylus coil and capacitor may be left unconnected. A pressure sensitive mechanism within the stylus may be used to selectively connect said other ends or terminals together once said stylus point member is pressed with sufficient force or pressure against a surface. Therefore, when the stylus is not pressed against a surface, for example a surface containing a number of transmit and receive coils which may be used to determine the presence, position and/or movement of the stylus, the stylus coil and capacitor is not connected as resonant pair, and their resonance may be inhibited. When the stylus is pressed with sufficient force against a surface, said stylus coil and capacitor may be connected together and may resonate at the first resonant frequency, for example with energy obtained from transmit coils in the surface. Receiver coils in said surface may be used to determine the stylus presence, position and/or movement by detecting the resonance of said stylus coil and capacitor at the first resonant frequency. Charge transfer based measurement circuitry and methods may be used for said detection.

The present invention further teaches specific gestures for a trackpad, touchscreen or other device which utilize measurement circuitry to simultaneously or nearly simultaneously detect finger and stylus engagement of said trackpad, touchscreen or other device. Said measurement circuitry may be based on charge transfer methods or techniques and said stylus may be an inductive stylus similar to that described elsewhere in the present disclosure. Said engagement by finger may be proximity or touch actions or gestures. Said engagement by stylus may be stylus activation, stylus proximity or stylus touch or contact on said trackpad, touchscreen or other device.

In a first exemplary stylus & touch gesture, a user may press a stylus against a trackpad with sufficient force, or to just make contact with said trackpad. Once said stylus press or contact is detected, the user may use his/her finger to reposition a displayed cursor, said displaying which may be done on a display or screen distinct from the trackpad. When stylus contact with said trackpad ceases, the cursor position may be locked or set. Said trackpad and associated circuitry may make use of a charge transfer measurement based method or technique to monitor and detect the simultaneous presence, position and/or movement of the finger and stylus, wherein said stylus may be an inductive stylus similar to that described elsewhere in the present disclosure.

In a related second exemplary stylus and touch gesture, the user need not press the stylus against the trackpad with sufficient force, or make contact with the stylus on the trackpad, but may merely activate the stylus, wherein said activation may be detected by the trackpad, where after the user may use his/her finger to reposition a displayed cursor, similar than before. A tap or double tap by either or both said finger or/and the stylus may be used to lock or set the new position of the cursor, or other touch or stylus gestures may be used for said locking or setting. As before, the trackpad and associated circuitry may make use of a charge transfer measurement based method or technique to monitor and detect the simultaneous presence, position and/or movement of the finger and stylus.

In another exemplary stylus gesture embodiment, a user may press a side-switch on the stylus, or another switch, which may be detected by said trackpad or another device. Once said side-switch is depressed, the user may drag the point of the stylus across the surface of the trackpad without a corresponding line being drawn on an associated display. Said dragging may for example be used to reposition a cursor on said associated display. The trackpad and associated circuitry may make use of a charge transfer measurement based method or technique to monitor and detect the presence, position and/or movement of the stylus, as well as the status of said side- or other switch, wherein said stylus may be an inductive type similar to that described elsewhere in the present disclosure.

In another exemplary embodiment, said trackpad may be used as a secondary display, either to replicate all content on a primary display, or to display or replicate sections of the primary display content. In other words, the trackpad may function as a secondary display, for example using an LCD, and may also sense simultaneous stylus and user finger engagement of said trackpad, for example using charge transfer based measurement circuitry and methods, wherein said stylus may be an inductive type similar to that described elsewhere in the present disclosure. Such an embodiment may allow the trackpad to, for example, display selected content, and allow the user to interact with said content simultaneously via stylus and finger. For example, the signature box of a document displayed on the primary display may be replicated on the trackpad display. A user may reposition said box with his/her finger until a position convenient for signing with said stylus is reached. Once said signing is complete, the user may release the replicated content by moving his/her finger away from said trackpad, which may result in the trackpad display becoming blank, or the signature box “jumping” back to the primary display in an animation, as examples.

The present invention also teaches that finger touch, or touch by other appendages or objects, or proximity inputs may be ignored during specific usage cases for stylus input. For example, when a trackpad, touchpad, touchscreen or other device which embodies the present invention senses touch input over a larger area than a predetermined maximum, it may elect to ignore the touch input while continuing to process stylus input. The stylus may be an inductive type similar to that described elsewhere in the present disclosure, or another type. The trackpad, touchscreen or other device may utilize charge transfer based measurement circuitry and methods to detect touch and stylus input. Such an embodiment may be advantageously used for rejection of user palm input during stylus inking gestures, as one application example. The touch-input-ignore mode may also be selected based on criteria other than touch area. For example, the separation distance between stylus contact and touch inputs may be used. Or a specific touch size may be required in the vicinity of stylus input. The present invention is not limited in this regard.

### BRIEF DESCRIPTION OF THE DRAWINGS

The invention is further described by way of examples with reference to the accompanying drawings in which:

FIG. 1A shows and exemplary embodiment of the present invention in the form of a push button with a metal dome, a flexible member and a magnetic member, all located over a coil.

FIG. 1B shows a top view of the metal dome of FIG. 1A in an unactuated and an actuated state.

FIG. 1C shows a side sectional view of the embodiment in FIG. 1A in an unactuated and an actuated state.

FIG. 2A shows a flat conductive member with a plurality of central slits, and how an opening forms when pressure is applied to or proximate to the slits.

FIG. 2B shows the member of FIG. 2A used with supports and an arching flexible member as part of an inductive sensing push button embodiment.

FIG. 2C shows an exemplary side sectional view of an embodiment using the structure of FIG. 2B.

FIG. 3 shows a flexible member with a single centrally located slit, and how an opening forms and closes, dependent on the amount of pressure applied and whether the flexible member snaps through or not.

FIG. 4 shows an exemplary inductance sensing based push button embodiment with a rotating member located over a coil.

FIG. 5 shows an exemplary inductance sensing based push button embodiment using two rotating members located over a coil.

FIG. 6 shows an exemplary side sectional view of the embodiment of FIG. 5.

FIG. 7 shows an exemplary embodiment of an inductive sensing based push button structure.

FIG. 8 shows a typical prior art button latching mechanism

FIG. 9 shows an exemplary embodiment of an inductive sensing based latching push button structure.

FIG. 10 shows an exemplary embodiment which utilizes a spring or flexible material to ease manufacturing constraints.

FIG. 11 shows an exemplary embodiment in the form of a latching switch using differential inductance measurements.

FIG. 12 shows an exemplary embodiment in the form of a transmit and receive inductor array used with a passive stylus as part of a user interface system, with interleaved receive inductors.

FIG. 13 shows another stylus and transmit and receive array, with spaced apart receive inductors.

FIG. 14 shows typical counts values obtained for the user interface device of FIG. 13 with the stylus at various locations.

FIG. 15 shows a stylus of the present invention which may be used to keep the tip of said stylus orthogonal to the sensing surface.

FIG. 16 shows an exemplary stylus of the present invention, which may utilize selective short-circuiting of a coil around a ferrite tip of the stylus to affect inductance measurements

FIG. 17A shows exemplary constructional details in a sectional view of the stylus of FIG. 16

FIG. 17B shows another exemplary stylus which embodies the present invention, with an additional side-button.

FIG. 18A shows an exemplary stylus of the present invention, which may utilize a change in resistance coupled to a coil around a ferrite tip of said stylus to signify pressure applied.

FIG. 18B shows details of the resistance board of FIG. 18A

FIG. 19 shows an exemplary stylus of the present invention, which may utilize a changing air gap to influence a measured inductance, thereby signifying an amount of pressure applied.

FIG. 20 shows an exemplary variation of the embodiments depicted in FIG. 12 and FIG. 13, wherein the transmit coil is driven at a frequency other than the theoretical resonant frequency, to avoid cross-coupling and multi-resonance effects.

FIG. 21 shows an exemplary button which embodies the present invention, wherein selective short-circuiting of a coil around a ferrite member may be utilized to signify button actuation.

FIG. 22 shows an exemplary stylus embodiment of the present invention where a parallel resonant LC pair is selectively short-circuited.

FIG. 23 shows another exemplary stylus embodiment of the present invention where a resonant LC pair is selectively connected/disconnected to/from each other.

FIG. 24 shows yet another exemplary stylus embodiment of the present invention where a resonant LC pair is selectively connected/disconnected to/from each other.

FIG. 25 shows an exemplary embodiment of the present invention with simultaneous stylus and touch detection to position a displayed cursor.

FIG. 26 shows an exemplary embodiment of the present invention which allows cursor repositioning without drawing a line.

FIG. 27 shows an exemplary embodiment of the present invention where the trackpad used to detect stylus and finger interaction also functions as a secondary display.

FIG. 28 shows an exemplary embodiment in the form of a three-state push-button, with actuation sensed across a sealed surface.

### DETAILED DESCRIPTION OF EMBODIMENTS

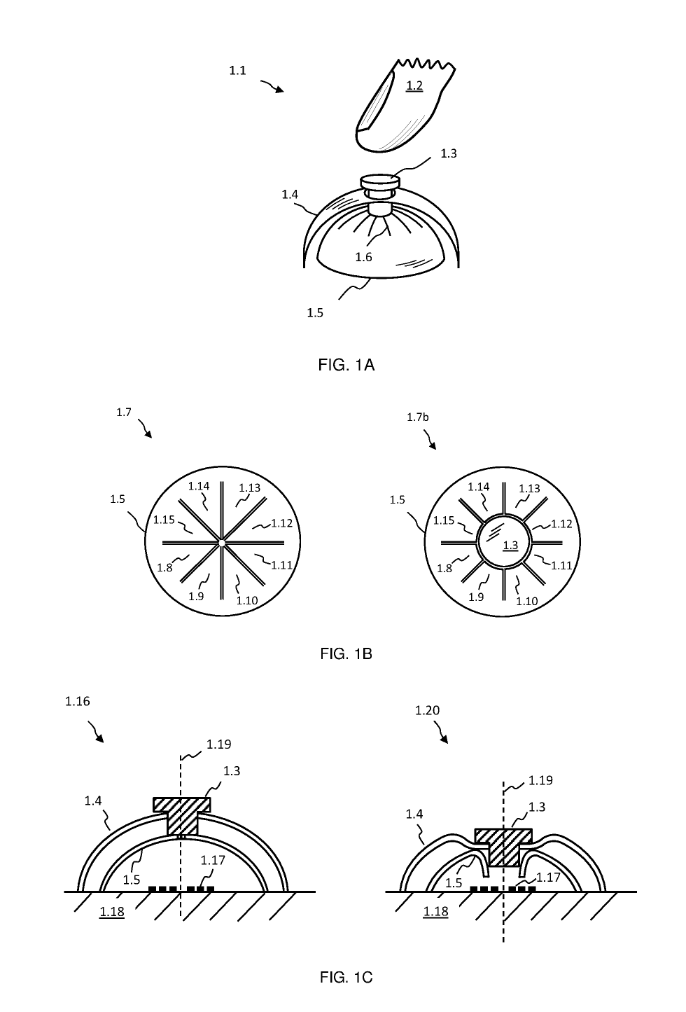

In FIG. 1A an exemplary inductive sensing based push button embodiment of the present invention is depicted at 1.1. A users finger 1.2, or another engaging object or device, may apply pressure or force to a magnetic member, for example a ferrite member, 1.3, or to material attached to member 1.3. The latter may be supported and held in place by a flexible member 1.4, which may be resilient in nature and deflect downwards when pressed. If sufficient force or pressure is applied to member 1.3, or to material attached to it, and thereby to flexible member 1.4, the latter may suddenly give way and substantially deflect downwards, known as snapping through. Members 1.3 and 1.4 are located over a conductive dome structure 1.5, which in turn is located over a coil or inductive structure (not shown), wherein said coil may experience eddy current losses due to dome 1.5, which may result in a decreased inductance measured by an inductive sensing circuit (not shown), for example a charge transfer based inductive sensing circuit, for said coil. Dome 1.5 may have a number of slits 1.6 cut into its apex, as shown. These may facilitate creation of an opening centrally in said dome when sufficient pressure or force is applied to the dome apex.

FIG. 1B shows a top view of dome structure 1.5 at 1.7, with the eight sections 1.8 to 1.15 formed by said slits. The dome 1.5 may be fashioned such that sections 1.8 to 1.15 overlap each other and make substantial electrical contact, despite the presence of said slits when the button structure is in an unactuated state. Magnetic member 1.3's position and the flexibility of member 1.4 may be used to ensure that member 1.3 apply just enough pressure onto said overlapping slits to ensure electrical contact when said button is in an unactuated state. This may increase the amount of eddy currents which flow in dome 1.5 due to the magnetic field of a coil (not shown) located underneath the dome, and improve the signal to noise ratio of the dome switch structure between an unactuated and actuated state. Alternatively, the slit dimensions and locations may be optimised for the inductive sensing frequency used to ensure that the eddy current paths are not excessively broken by said slits. When the magnetic member 1.3 is pressed downwards with sufficient force onto dome 1.5, it may force the tips of sections 1.8 to 1.15 apart and create an opening, as shown in exemplary manner at 1.7b in FIG. 1B. This may allow magnetic field of a coil (not shown) to couple with magnetic member 1.3.

In other words, as depicted in exemplary manner in side sectional view 1.16 in FIG. 1C, when less than a specific minimum amount of force is applied to the apex of dome 1.5, it effectively remains a closed structure, preventing magnetic fields of coil 1.17 to couple with magnetic member 1.3, and causing a decrease in the inductance of coil 1.17 due to eddy current losses in said dome. As depicted at 1.16 and 1.20, the magnetic axis of coil 1.17 may coincide with the centre of dome 1.5 and magnetic member 1.3, with the latter supported by flexible member 1.4 as described earlier. Coil 1.17 may be planar in nature and located on a substrate 1.18, as depicted in FIG. 1C, or it may have another form factor, or suspended in air etc. It may also be located on the underside of substrate 1.18. Coil 1.17 also need not be a coil, but may be any relevant structure which emanates a magnetic field.

Once a user applies more than a specific minimum amount of force or pressure to magnetic member 1.3, or to material attached to it, flexible member 1.4 may snap through, as shown at 1.20 in FIG. 1C. In this actuated state of the push button structure, magnetic member 1.3 may apply sufficient force to the apex of dome 1.5 to force an opening, due to said slits, and may protrude through said dome and move substantially closer to coil 1.17, as shown. As a result, the inductance of coil 1.17 may suddenly, simultaneous with the snap-through event, increase significantly, due to the proximity of magnetic member 1.3 and the improve coupling of magnetic fields emanating from coil 1.17 with said magnetic member. The sudden increase in inductance may be used to discern the push button actuation event.

A flat conductive member, with a plurality of centrally located slits, may also be used to practise the present invention through realization of an inductive sensing based push button structure. FIG. 2A to FIG. 2C depict such an embodiment in exemplary manner. At 2.1 in FIG. 2A, a flat, or substantially flat, conductive member 2.2 with centrally located slits 2.3 is shown. The dimensions of said slits may be optimised in terms of the inductive sensing frequency used and the amount of eddy current losses achievable in an unactuated state. At 2.4 in FIG. 2A, a typical opening 2.5 which results from application of force or pressure to member 2.2 is depicted. According to the present invention, opening 2.5 may be used to facilitate coupling of magnetic fields through member 2.2 with a magnetic member proximate to the opening.

As shown at 2.6 in FIG. 2B, member 2.2 may be supported and held in place by upright members 2.7 and 2.8, wherein these may be fashioned out of plastic, for example. An arching flexible member 2.10 may be placed over member 2.2, and may also be attached to supports 2.7 and 2.8, as shown. A magnetic member (not shown in FIG. 2B) with high relative permeability, for example a ferrite member, may be attached to the apex of member 2.10, aligned with the centre of member 2.2. FIG. 2C depicts exemplary unactuated and actuated states of the push button structure in side sectional views at 2.11 and 2.15 respectively. As shown at 2.11, ferrite member 2.12 may be attached to the apex of flexible member 2.10. It may be aligned with the centre of member 2.2, as well as with the magnetic axis of a coil or inductive structure 2.13. In the embodiment depicted, coil 2.13 is located on the underside of a substrate or surface 2.14. In the unactuated state shown at 2.11, magnetic member 2.12 does not press on conductive member 2.2 with sufficient force to cause slits 2.3 to bend open (as shown at 2.5 in FIG. 2A), with conductive member effectively forming a closed or semi-closed conductive surface, causing maximum eddy current losses for coil 2.13, and an associated minimum inductance value. However, if a user applies sufficient force to flexible member 2.10, causing it to snap through, the button may enter an actuated state as depicted at 2.15, wherein magnetic member 2.12 presses with sufficient force onto member 2.2 to force said slits to bend open, as depicted by 2.16 and 2.17. This may facilitate coupling of the magnetic field of coil 2.13 with magnetic member 2.12, leading to a sudden increase in the inductance measured for coil 2.13, wherein said sudden increase may be used to detect and annunciate the actuation of the push button structure.

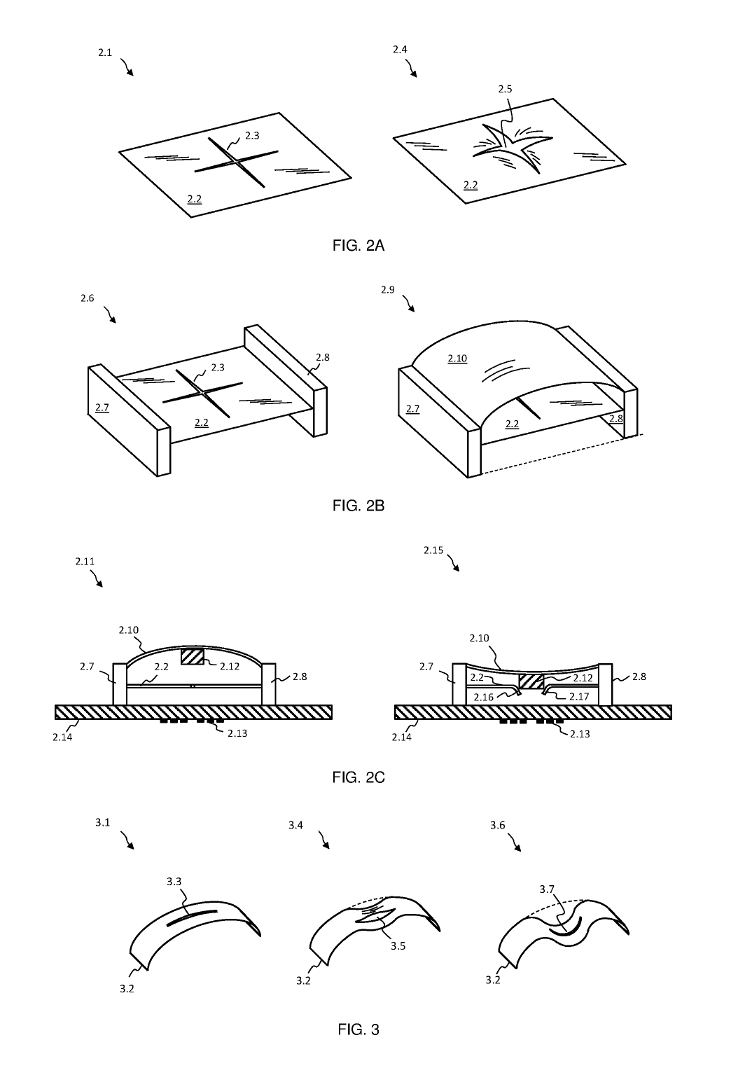

According to the present invention, it may further be possible to realize a double action inductive sensing based push button using a rectangular, flexible dome structure with a single lengthwise slit. FIG. 3 depicts such a flexible dome structure 3.2 in an exemplary manner. Said lengthwise slit can be seen at 3.3. When no pressure is applied to member 3.2, the slit is substantially closed, as shown at 3.1, and may cause significant eddy current losses for an associated coil (not shown) It has been observed that when a first amount of pressure is applied, as shown at 3.4, an opening 3.5 with a fair width relative to the width of member 3.2 forms, as shown at 3.4, but when a second, larger amount of pressure, sufficient to cause snap through, is applied, member 3.2 may bend through, with the slit substantially closing again, as shown in exemplary manner at 3.7. According to the present invention, such a sequence of said slit being substantially closed, then opening or widening, then closing again may be used to realize a double action push button. For example, the state depicted at 3.4 may be used to allow coupling of a magnetic member (not shown) with a coil (not shown). In such an embodiment, one may expect the inductance of the coil to be at a low first value for the state shown at 3.1, then increasing to a second maximum value due to said magnetic member coupling in the state shown at 3.4, and finally suddenly decreasing to a third minimum value for the state shown at 3.6, with the third value lower than said first value.

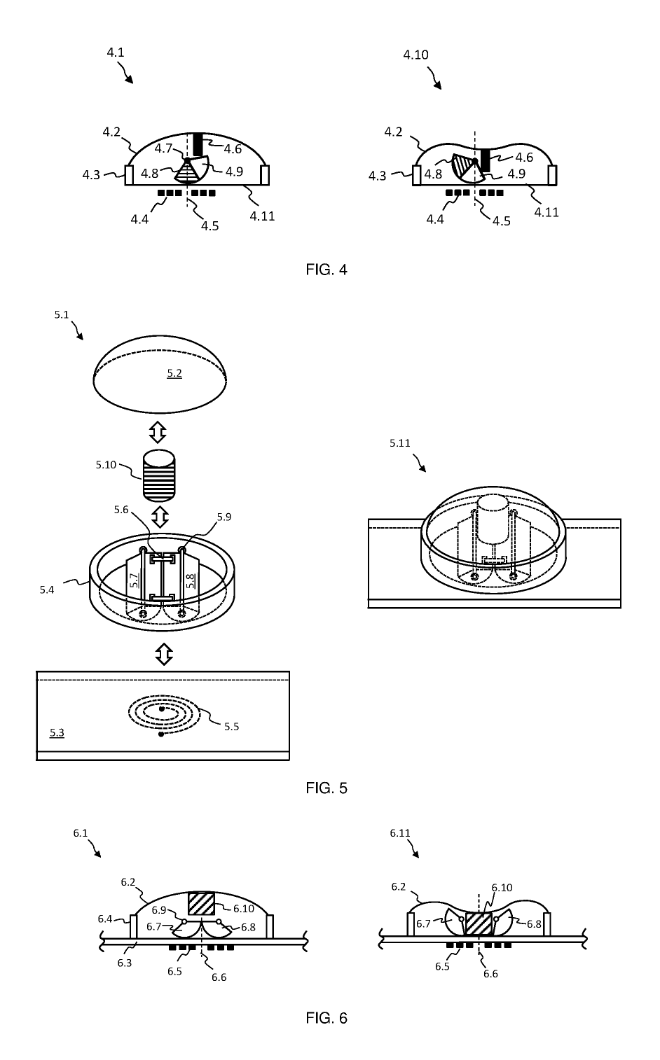

FIG. 4 shows yet another exemplary embodiment of the present invention for an inductive sensing based push button structure. An unactuated push button state is depicted at 4.1 and an actuated state at 4.10. The embodiment comprises a flexible dome 4.2, for example a plastic dome, supported by supports 4.3 above a substrate or surface 4.11. A coil or inductive structure 4.4 may be located below substrate 4.11, with the magnetic axis 4.5 of coil 4.4 being slightly offset from the centre or apex of dome 4.2. A pin or protrusion 4.6 may be located at the apex of said dome, as shown. A swivelling member, comprising two sections 4.8 and 4.9, may swing about an axis 4.7, wherein said axis 4.7 is coincident with the magnetic axis 4.5 of the coil or inductive structure. Section 4.8 may consist partially or wholly of conductive material, whereas section 4.9 may consist partially or wholly of magnetic material with high relative magnetic permeability. For example, section 4.8 may consist partially or wholly of aluminium, and section 4.9 may consist partially or wholly of ferrite. During a first unactuated state of the push button structure, as depicted at 4.1, the swivelling member may be positioned such that section 4.8 lies substantially over coil 4.4. This may result in increased eddy current losses for coil 4.4, due to the eddy currents induced by said coil into section 4.8, and a corresponding minimum inductance value measured for coil 4.4. Flexible members (not shown), for example springs, may be used to return the swivelling member to the position shown at 4.1 after the push button is released.

Application of more than a specific amount of force or pressure to flexible dome member 4.2 may result in the dome snapping through, as shown at 4.10. As a result, the pin or protrusion 4.6 may press down onto said swivelling member, causing it to swing so that section 4.9 becomes substantially located over coil 4.4. Due to the higher relative magnetic permeability of section 4.9, this may cause a noticeable increase in the inductance measured for coil 4.4, wherein said increase may be used to detect and annunciate actuation of the push button structure.

FIG. 5 and FIG. 6 depict an exemplary embodiment related to that of FIG. 4, using two swivelling members. An exploded and collapsed view is presented at 5.1 and 5.11 respectively. A flexible dome structure 5.2 may be supported by a ring-like structure 5.4 over a substrate 5.3, wherein a coil 5.5 may be located on the underside of the substrate. A magnetic member with high relative permeability, for example a ferrite member 5.10 may be attached to the apex of said dome 5.2, wherein the magnetic axis of coil 5.5 coincides, or substantially coincides, with the magnetic axis of member 5.10. Two swivelling members 5.7 and 5.8 may be mounted within said ring-like structure, rotating about axes as shown at 5.9, and may be returned to a first position, wherein the two swivelling members have a minimum gap between them, by flexible or resilient members 5.6, which may be, as an example, springs or rubber bands. Exemplary operation of the push button embodiment may be described in more detail with reference to FIG. 6, which provides sectional side views of the push button in an unactuated state and in an actuated state at 6.1 and 6.11 respectively. As shown at 6.1, flexible dome 6.2 may be mounted onto ring-like support 6.4, and may have a magnetic member 6.10, with high relative magnetic permeability, mounted to or located at or near the apex of dome 6.2. A substrate 6.3 may be used to support member 6.4, and may carry a coil or inductive structure 6.5 on its underside, with the magnetic axis 6.6 of said coil coinciding, or substantially coinciding with the centre of magnetic member 6.10. Two swivelling members 6.7 and 6.8 may be mounted within ring-like member 6.4, and rotate about axes as shown at 6.9. The swivelling members may consist partially or wholly of a conductive material. For example, members 6.7 and 6.8 may be fashioned out of aluminium. Or they may be fashioned out of plastic, and have only their undersides covered with conductive material, for example with a copper layer. As such, when swivelling members are in the position shown at 6.1, they may cause a fair amount of eddy current losses for coil 6.5. This may reduce the amount of inductance measured for coil 6.5 to a first minimum value.

When a user, or another object, applies more than a specific minimum force to dome 6.2, it may snap through, causing actuation of the push button structure, as shown at 6.11. As illustrated in exemplary manner, said snapping through may result in magnetic member 6.10 pushing swivelling members 6.7 and 6.8 apart, which may allow member 6.10 to suddenly move significantly closer to coil 6.5. As a result, because swivelling members 6.7 and 6.8 swing away from coil 6.5, the eddy current loading of coil 6.5 may suddenly reduce significantly, leading to a first increase in the measured inductance of coil 6.5. In addition, due to magnetic member 6.10 suddenly moving closer to coil 6.5, improved coupling between members 6.10 and 6.5 may result, with a corresponding decrease in magnetic reluctance and a second increase in the measured inductance of coil 6.5. The actuation of said push button may be detected from said first and second increases in measured inductance, followed by annunciation.

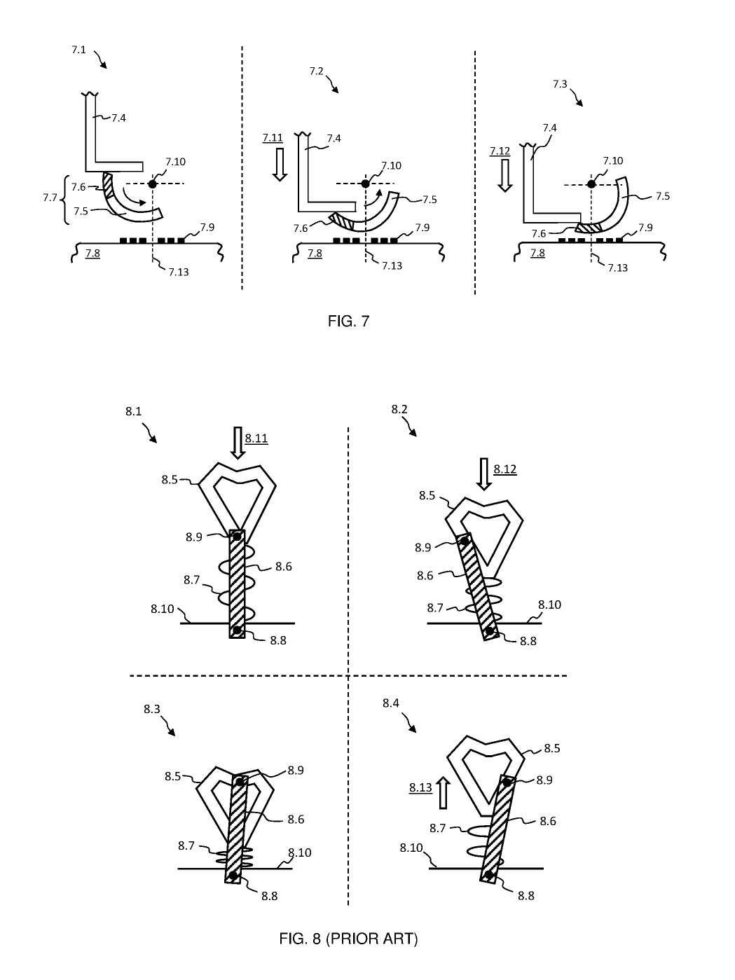

According to the present invention, it may be advantageous to move a conductive member, or a conductive section of a member, closer to a monitored coil or inductive structure before moving a magnetic member closer, since it may allow improved detection of push button, or another user interface structure, actuation. FIG. 7 depicts an exemplary embodiment which may be used to practice this teaching. The embodiment is shown in a first, unactuated state at 7.1. An actuating arm 7.4 may be used to press onto a rotating member 7.7 comprising sections 7.5 and 7.6. Section 7.5 may consist partially or wholly of a conductive material, for example of copper or aluminium, and section 7.6 may consist partially or wholly of a magnetic material with high relative magnetic permeability, for example of ferrite. It is to be appreciated that the material composition of the two sections may be interchanged, for example section 7.5 may consist of ferrite and section 7.6 may consist of aluminium, without moving beyond the scope of the present invention, with an inverse relation applied to inductance values as described below. The rotating member 7.7 may rotate about an axis 7.10, wherein said axis may be aligned with the magnetic axis 7.13 of a coil 7.9 located on a substrate or surface 7.8 below, or in proximity to, rotating member 7.7. The inductance of coil or inductive structure 7.9 may be measured to determine actuation of said push button or other user interface structure.

As illustrated at 7.2, when a user or another object applies a first amount of force 7.11 in a downwards direction, actuating arm 7.4 presses down on said rotating member, causing it to rotate by a first amount about axis 7.10. Due to the unique shape of the rotating member, said first amount of rotation may cause section 7.5 to move closer to coil 7.9, as illustrated at 7.2. Due to the conductive nature of section 7.5, this may increase the amount of eddy current losses experienced by coil 7.9, which may result in a first reduction in the measured inductance value for coil 7.9. Said first reduction may be used to detect and annunciate said application of first amount of force 7.11 to the push button or other user interface structure.

According to the present invention, when a user applies a second amount of force 7.12 in a downwards direction to the push button or other user interface structure, actuating arm 7.4 may press down further on the rotating member, as shown at 7.3. This may cause further rotation of the rotating member, and magnetic section 7.6 to move closer and/or over coil 7.9, as depicted. Due to the higher relative magnetic permeability of section 7.6, coil 7.9 may experience a reduction in the reluctance of its magnetic field path, resulting in a higher measured inductance value for coil 7.9. This increase may be used to discern application of said second amount of force to the push button or other user interface structure.

In prior art latching push button and other user interface devices, use is often made of a latching mechanism similar to that depicted in FIG. 8. According to the present invention, such a latching mechanism, and others, may be used with the embodiments disclosed here, as well as with other embodiments falling within the scope of the claims of the present invention, to facilitate latching operation of push button and other user interface structures or devices. The mechanism is shown in an unlatched state at 8.1 in FIG. 8. An arm member 8.6 is constrained to surface 8.10 and may rotate about axis or pin 8.8 located at one end of member 8.6. Another pin 8.9 is located at the distal end of arm member 8.6. Pin 8.9 is constrained to move along a cam or path in a downwards/upwards movable member 8.5, wherein said path or cam roughly resembles a heart shape. Downwards being in the direction as shown by 8.11. A spring or other resilient member 8.7 pushes member 8.5 upwards, and provides the force to either keep the mechanism in a latched state, or to return it to an unlatched state. If a user or other object presses down on member 8.5 with sufficient force 8.12, as depicted at 8.2, arm member 8.6 should swing to one side while pin 8.9 travels upwards in the heart shaped path as member 8.5 moves downwards. Spring 8.7 becomes compressed as energy is stored in it. When member 8.5 is pressed down far enough, pin 8.9 moves over a first ridge, and reaches a latched position, as shown at 8.3. Said latched position is slightly offset or biased toward the one side, to facilitate unlatching. The force of spring 8.7 keeps pin 8.9 and the mechanism in the latched position until the user or other object presses briefly down again on member 8.5. This cause pin 8.9 to move over the second ridge and to travel down the heart shaped path, with member 8.5 correspondingly moving upwards under the force of spring 8.7, as shown at 8.4, until the unlatched position of 8.1 is reached again.

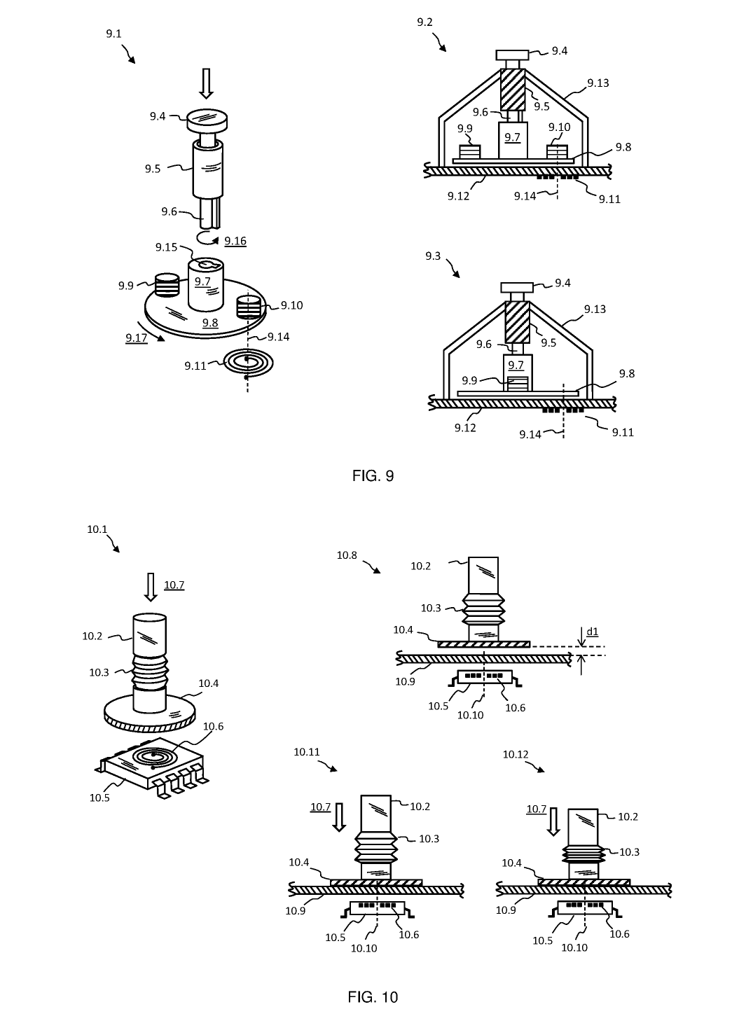

The present invention may also be embodied in a push-button structure which makes use of the latching mechanism commonly found in so called “click” or “retracting” pens. For example, refer to U.S. Pat. No. 3,205,863 awarded to the Parker Pen Company in 1965 for a typical latching mechanism. These mechanisms are typically characterised by turning the pen tip by ninety degrees when the pen rear end is pushed to place the pen in a latched writing state, and turning the pen tip by a further ninety degrees when said rear end is pushed again to place the pen in a latched retracted state. In other words, the mechanism rotates the pen tip with one-hundred-and-eighty degrees symmetry. Further, such click pens and their mechanisms have evolved over the ensuing decades to not only be extremely ubiquitous, but to also be mass producible at high volume and low cost while maintaining reliability. The present invention teaches that these mechanisms may advantageously be used to realize inductive sensing based push buttons. An exploded view of an exemplary embodiment is shown at 9.1 in FIG. 9. Member 9.5 comprise a latching mechanism as typically found in click pens, with button 9.4 used to push mechanism 9.5 into a latched, extended state, or into a latched, retracted state. Instead of having an ink pen tip, mechanism 9.5 has a keyed tip 9.6 which slots into a corresponding keyed hole 9.15 in cylinder member 9.7. When button 9.4 is pressed to place mechanism 9.5 into a first, latched extended position, keyed tip 9.6 may turn by ninety degrees due to the functioning of mechanism 9.5, as described above. Should button 9.4 be pressed again to place mechanism 9.5 into second, latched retracted position, keyed tip 9.6 may turn by a further ninety degrees, due to the functioning of mechanism 9.5. Keyed tip 9.6 may continually be located within keyed hole 9.15, or it may only be located in said hole when mechanism 9.5 is in an extended state, or when keyed tip 9.6 turns. One of the unique characteristics of the mentioned click pen mechanisms is that the pen tip first turns through ninety degrees before going into a retracted state. In either case, due to said turning 9.16 of keyed tip 9.6, cylinder 9.7 and plate 9.8 may turn in a corresponding manner, as indicated by 9.17. Plate 9.8 may be partially or wholly fashioned out of conductive material, for example from aluminium or copper. Further, plate 9.8 may contain holes or apertures (not shown) which allows magnetic members 9.9 and 9.10 to couple through said plate. Magnetic members 9.9 and 9.10 may have high relative magnetic permeability, for example they may be fashioned out of ferrite. A coil or inductive structure 9.11 may be located underneath plate 9.8 in such a manner that the magnetic axis of coil 9.11 aligns with the centre of either magnetic member 9.9 or 9.10 when plate 9.8 rotates such that one of said magnetic members is centred over the coil. Similar to other embodiments described herein, when the conductive disk or plate 9.8 is located over said coil 9.11, the coil may experience eddy current losses, and a decrease in inductance, whereas if one of the magnetic members 9.9 or 9.10 is located over coil 9.11, coil inductance may increase due to a reduction in magnetic reluctance for the coil magnetic field path. Such a decrease or increase in coil inductance, dependent on the rotational position of plate 9.8, and therefore of keyed tip 9.6, may be used to realize a cost effective, reliable push button structure using the well-known click mechanism 9.5, as described earlier, which may provide users with a very distinct click and tactile feedback upon button actuation.

Side views of the above embodiment are presented at 9.2 and 9.3 to further clarify operation. At 9.2, button 9.4 has been pressed to result in click pen mechanism 9.5 being in a first latched state, for example in an extended state, with keyed tip 9.6, and correspondingly cylinder 9.7 turned so that magnetic member 9.10 lies over coil 9.11, with the magnetic axis 9.14 of the coil aligned with the centre of member 9.10. As such, the inductance of coil 9.11 may be at a first, maximum value due to the coupling of member 9.10 with said coil through an aperture (not shown) in conductive disk 9.8. Member 9.13 represents support arms or the push button housing. If a user or another object presses button 9.4 again with sufficient force to result in mechanism 9.5 to enter a second latched state, for example a retracted state, keyed tip and disk 9.8 may turn through a first ninety degrees, as discussed earlier, resulting in the situation presented at 9.3. As is evident, magnetic member 9.10 has moved away from coil 9.11 and only the conductive material of disk 9.8 lies over said coil. This may cause an increase in eddy current losses experienced by coil 9.11, with a resultant decrease in inductance resulting in a second, minimum inductance value. Therefore, the push button state may be determined by checking whether the inductance value for coil 9.11 is at said first maximum value or second minimum value.

For clarity's sake, when the push button is in the state shown at 9.3, and button 9.4 is pressed again with sufficient force to cause mechanism 9.5 to enter an extended state again, disk 9.8 should rotate by another ninety degrees such that magnetic member 9.9 lies over coil 9.11. Should this be followed by another press event onto button 9.4 to cause a third rotation of ninety degrees, magnetic member 9.9 should rotate away from coil 9.11, with only the conductive material of disk 9.8 lying over coil 9.11. A further press onto button 9.4 to cause a fourth rotation of ninety degrees should again result in the orientation of members as depicted at 9.2.

Yet another exemplary embodiment of the present invention is depicted by FIG. 10. At 10.1 a moving member 10.2 is shown, wherein member 10.2 may form part of a button or switch structure as described elsewhere in the present disclosure, or it may form part of apparatus used for any other suitable application, for example it may form part of a window or door open-close sensor. Moving member 10.2 is attached to magnetic flux modifying member 10.4 via resilient and compressible member 10.3. The latter may, for example, be fashioned out of rubber, or it may be a spring. Member 10.4 may comprise conductive material or it may comprise magnetic material with high magnetic relative permeability, for example ferrite. Member 10.4 is located over an inductive structure or coil 10.6 within an IC package 10.5. Inductive structure or coil 10.6 need not be integrated into an IC, but may be also be any external coil or inductive structure. In a preferred, but non-limiting, embodiment, coil 10.6 is realized on a silicon die of IC 10.5, wherein the IC may also be used for inductance measurement, for example with charge transfer based inductance sensing apparatus and methods. When a downward force in direction 10.7 is applied to moving member 10.2, for example by a user, members 10.2, 10.3 and 10.4 should move closer to coil 10.6. If member 10.4 comprises conductive material, this may increase the eddy current load placed on said coil, which may result in reduced measured coil inductance. Conversely, if member 10.4 comprises magnetic material it should result in an increase in measured inductance for coil 10.6.

According to the present invention, an embodiment as shown in FIG. 10 may be used to ease the tolerance on the allowable amount of movement by member 10.2 to obtain a specific change in inductance and, for example, switch actuation. This may help to alleviate manufacturing effort and cost. Corresponding side-views as shown at 10.8, 10.11 and 10.12 further clarify the concept. For example, during a first state, with no force or pressure applied to moving member 10.2, member 10.4 may be at a distance d1 from a substrate 10.9, as shown at 10.8. Substrate 10.9 lies over IC 10.5 and coil 10.6, with the magnetic axis of said coil being at 10.10. The substrate 10.9 may be substantially permeable to magnetic fields, but may be used to seal against liquids, gases, dust and so forth. Therefore, the magnetic field of coil 10.6 may couple with member 10.4, resulting in a first measured inductance value for said coil when member 10.4 is at distance d1 above substrate 10.9. When a first amount of force or pressure is applied to moving member 10.2 in direction 10.7, member 10.4 may move towards substrate 10.9 for a distance d1 until is presses against said substrate, as shown at 10.11. The inductance for coil 10.6 may change to a second measured value due to member 10.4 being pressed against substrate 10.9. For example, if member 10.4 comprises conductive material, said second inductance value may be significantly lower than said first inductance value. As a result, IC 10.5, or another circuit, may detect and annunciate the movement of member 10.2 over distance d1. However, should moving member 10.2 be pressed or moved still further in direction 10.7, as shown at 10.12, the measured inductance value for coil 10.6 may stay substantially at said second value, since the additional movement only serves to compress member 10.3, as shown. This additional movement, while obtaining the same inductance value for coil 10.6, may facilitate easing of manufacturing tolerances for the allowable movement of member 10.2.

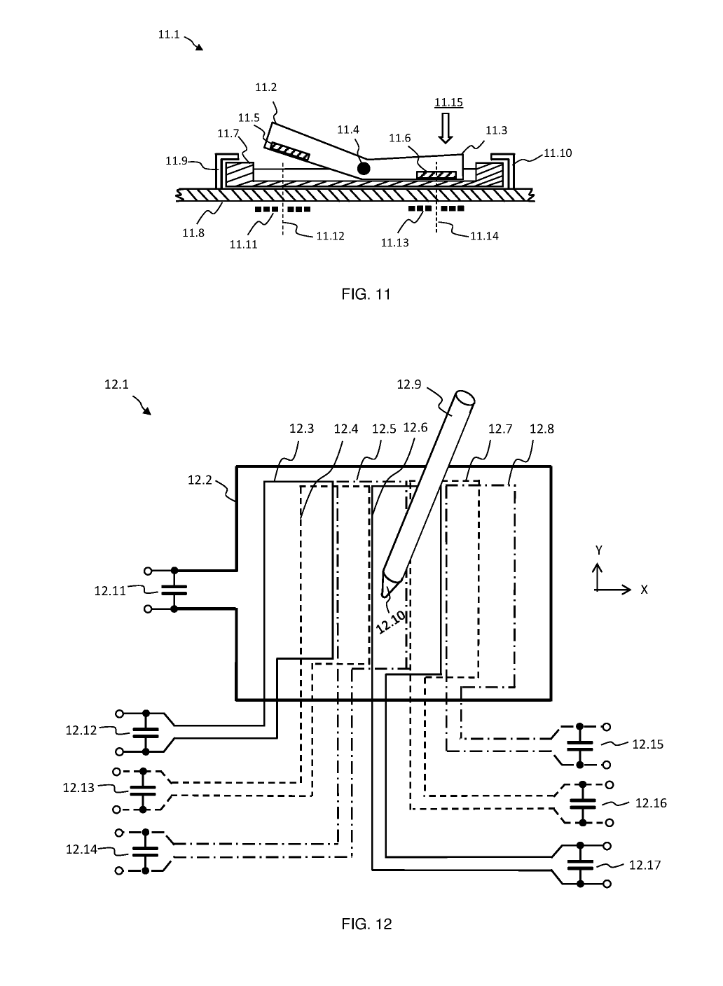

As discussed during the Summary section, the present invention further teaches that differential inductance measurements for two or more coils may be used to discern switch or button actuation or state change, or it may be used for other applications, for example other User Interface (UI) devices. FIG. 11 presents a side sectional view of an exemplary embodiment comprising a latching rocker switch at 11.1. Some elements of the switch structure share similarity with the well-known and ubiquitous wall light switch. For example, the latching mechanism is not shown or described, as it may comprise any of the numerous latching mechanisms known and used for rocker switches. However, the switch embodiment shown in FIG. 11 differs significantly from prior art rocker switches in its simplicity and the fact that it may allow complete sealing against liquids, gases, dust and so forth without undue cost or complexity.

The rocker member of said switch comprises two lengthwise ends 11.2 and 11.3. A metal member is located within each end, as respectively shown at 11.5 and 11.6. The rocker member may pivot or rotate about an axis 11.4 within a housing 11.7, wherein said housing is retained over substrate 11.8 by retaining members 11.9 and 11.10, as shown. The retaining members may comprise the one or other form of clips, as is known in the art, which may for example allow easy installation and replacement. Said retaining members may also be utilized to ensure accurate positioning of the rocker switch module over a first coil 11.11 and a second coil 11.13, with respective magnetic axes at 11.12 and 11.14, as shown. As such, when a user presses down on one end of the rocker member, for example on 11.3 in direction 11.15 as shown, metal member 11.6 moves into proximity of second coil 11.13 while metal member 11.5 moves away from first coil 11.11. As a result, the eddy current loading of second coil 11.13 may increase significantly, with a corresponding decrease in the measured inductance for coil 11.13, while the eddy current loading of first coil 11.11 may decrease with an associated increase in the measured inductance for coil 11.11. From the differential change in inductance values for coils 11.11 and 11.13, switch actuation may be discerned. Further, if a user presses down on end 11.2, the inverse of the above should occur, with inductance from coil 11.11 decreasing while the inductance for coil 11.3 increases.

The above described rocker switch embodiment may allow complete sealing by substrate 11.8 against liquid, gas and dust ingress, amongst others. Further, if metal members 11.5 and 11.6 are sealed within plastic, with all other parts above substrate 11.8 also fashioned out of plastic, the rocker switch may advantageously be used in severely corrosive environments, for example in marine environments.

Naturally, in the embodiment of FIG. 11, members 11.5 and 11.6 need not be limited to only conductive materials to practice the invention. For example, members 11.5 and 11.6 may be fashioned out of a magnetic material with high relative permeability, such as ferrite. In this case, when either member 11.5 or 11.6 moves closer to a particular coil due to pivoting of the rocker, the measured inductance of the coil should increase accordingly. Yet another exemplary embodiment may be realized by fashioning one member, for example member 11.5, out of a conductive material while the other member, in this case member 11.6, is made out of a magnetic material such as ferrite. In such an embodiment, one actuation state of the rocker switch may be characterised by the measured inductance for both coils being at a minimum value, with conductive member 11.5 being close to coil 11.11 and magnetic member 11.6 being far from coil 11.13, whereas for the other actuation state of said rocker switch the inductance for both coils should be at a maximum, with conductive member 11.5 being far from coil 11.11 and magnetic member 11.6 being close to coil 11.13.

An advantage of the embodiment shown in FIG. 11 may be that the differential inductance values for the two coils may simplify state determination at power-up or start-up. For example, if both members 11.5 and 11.6 is fashioned out of conductive material, and the measured inductance value for coil 11.11 is substantially lower than the value for coil 11.13 at power-up, associated circuitry (not shown) may determine that the rocker switch is in an actuation state where end 11.2 is close to coil 11.11 and end 11.3 is far from coil 11.13.

For the embodiment of FIG. 11, and elsewhere in the present specification and claims, it should be understood that wherever reference is made to an inductive structure or coil, or where a single inductive structure or coil is depicted in the drawings, one may substitute a mutual inductance coil or structure pair without departing from the teachings of the present invention. In other words, where one coil or inductive structure is described or depicted, the skilled reader may understand that self-inductance measurements are used, with conductive or magnetic material influencing the value of said self-inductance as per the particulars of each embodiment. According to the present invention, however, a mutual inductance coil or structure pair, that is a transmitter coil or structure and a receiver coil or structure, may be used in place of the single coil or inductive structure, with mutual inductance measurements used, wherein conductive or magnetic material, as per the particulars of each embodiment, may influence said mutual inductance values in a manner similar to the described or depicted influence of self-inductance values.

In FIG. 12, another exemplary embodiment in the form of a passive stylus user interface device or structure is depicted at 12.1. The user inter device may be used by a user to enter or select specific coordinates or items in or on an associated display, or may be used for writing and drawing, as is known in the art. A passive stylus 12.9 is located over a surface (not shown) with an inductive array comprising a transmitting coil 12.2 surrounding a plurality of receiving coils 12.3 to 12.8 arranged along the X-axis. It is to be appreciated that the present invention is not limited to single dimension arrays, but that transmitting and receiving coils may be arranged along the X-axis and Y-axis, as well as the Z-axis. In other words, one dimensional, two dimensional or three dimension inductor arrays may be used to practice the present invention. Further, although the coils are drawn for clarity sake as having only a single turn, both the transmitting and receiving coils may have any number of turns. Stylus 12.9 has a tip 12.10 comprising either magnetic material, for example ferrite, or metal, for example copper or aluminium. As such, when stylus 12.9 is located over a particular receiver coil, it may influence the coupling of that coil with the transmitting coil 12.2. For example, in the drawing, tip 12.10 is located over receiving coils 12.5 and 12.6. If tip 12.10 is fashioned out of a magnetic material such as ferrite, it may improve said coupling. Conversely, if tip 12.10 is fashioned out of a metal such as aluminium, it may reduce said coupling. If a charge transfer based measurement system is used to measure or monitor the receiving coils, improved coupling may typically result in a lower counts value and reduced coupling may result in an increased counts value.

By interleaving the receiving coils as shown in FIG. 12, accurate determination of stylus position may be improved, as information from more than one receiving coil may be available to determine location.

As shown at 12.11 to 12.17, each of the inductors or coils is connected to a capacitor to form a resonant pair. Using a resonant pair for the transmitting coil 12.2 may significantly increase the amount of energy available for coupling to receiving coils without requiring a high voltage or current source. Similarly, by using resonant pairs at the receiving coils, the amount of energy transferred to the measurement circuit may increase significantly, resulting in higher signal to noise ratios. However, the present invention should not be limited to the use of resonant pairs only, and may also be practised without the capacitors shown at 12.11 to 12.17. Or a resonant pair may only be used at the driving or transmitting coil or inductor, for example. The present invention should also not be limited to the use of only parallel resonance, with series resonant circuits which may also be used.

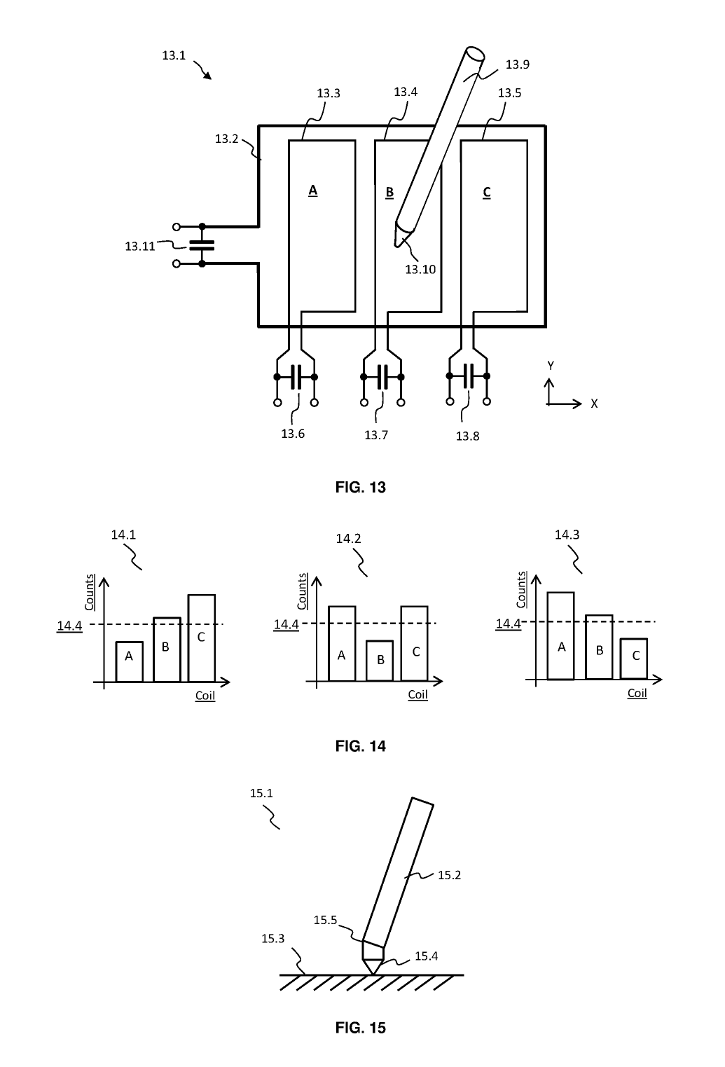

FIG. 13 and FIG. 14 depict an exemplary embodiment related to FIG. 12. A user interface comprising a passive stylus and an array of coils is depicted at 13.1. However, in this embodiment, receiving coils or inductors 13.3, 13.4 and 13.5 are spaced apart, and not interleaved or overlapping as before. A transmitting inductor or coil 13.2 surrounds said receiver inductors or coils, with resonant pair capacitors connected across the terminals of each coil, as shown at 13.6, 13.7, 13.8 and 13.11, as before. A passive stylus 13.9 with a conductive or magnetic material tip 13.10 is located over the surface (not shown) comprising the above mentioned coils. The stylus may be located over any of the coils, for example it may be located over receiver coil 13.3 at location A, over receiver coil 13.4 at location B or over receiver coil 13.5 at location C. Said transmitting inductors and receiver inductors may also be used for capacitive, or other, sensing, for example to sense user touch and proximity input. Alternatively, other electrode structures may be present in said surface (not shown), and used to sense user touch and proximity input via capacitive, or other, sensing.

If the stylus tip 13.10 comprises a magnetic material, for example ferrite, it may increase the coupling of a particular receiver coil with transmitter coil 13.2 when the stylus is located over the receiver coil, as is known in the art. However, when the characteristics of the coils and magnetic material is correctly designed, location of said stylus over a specific receiver coil may not only improve the coupling of that coil with transmitter coil 13.2, but may also reduce the coupling of neighbouring coils with transmitter coil 13.2, according to the present invention, which may significantly increase the amount of information available to determine stylus location.

For example, when a charge transfer based measurement system is used to monitor or measure the receiver coils of FIG. 13, count values as depicted in a qualitative manner in FIG. 14 may be obtained. When stylus 13.9, with a magnetic material such as ferrite in tip 13.10, is located over coil A, counts values for coils A, B and C as shown at 14.1 may be obtained. Level 14.4 represents a reference counts value as obtained when the stylus is not located near any of the receiver coils. As expected, the counts values for coil A drops significantly from the reference value 14.4, given that the magnetic material in stylus tip 13.10 which is located over coil A improves coupling. However, an unexpected result is obtained for coils B and C. Intuitively one would expect the counts value for coil B to be somewhat lower than the reference value 14.4, given that the magnetic material of the stylus tip is not over coil B, but near it, and therefore may still improve coupling. Similarly, one would expect the counts for coil C to be slightly lower than the reference level 14.4, or at least equal to it. However, it has been observed by the inventors that the result as shown at 14.1 is obtained when the magnetic material stylus tip is located over coil A, with counts for coil B being a bit higher than the reference level, and counts for coil C being substantially higher than the reference level. In other words, coil B effectively experience slightly reduced coupling with transmitter coil 13.2 when the magnetic tipped stylus is over coil A, and coil C effectively experience substantially reduced coupling. This is an unexpected result which may be advantageously applied to locate stylus position.

The bar-graph at 14.2 qualitatively shows typical counts values obtained when said stylus with a magnetic material tip is located over coil B. Once again, the low value for coil B is expected, but the increase of counts values for coils A and C above the reference level 14.4 is unexpected, given that said magnetic material tip is located close to coils A and C, and one would expect it to improve coupling somewhat. However, the result as shown at 14.2 is advantageous, even though unexpected, as it effectively increases difference between the signal for the coil where said stylus is located and its neighbouring coils, improving signal to noise ratio.

The bar-graph at 14.3, obtained when said stylus with a magnetic material tip is located over coil C, is the inverse of that shown at 14.1 and discussed, and therefore fairly self-explanatory, and will not be elaborated on for brevity's sake.

The present invention therefore teaches that it may be possible to design a user interface system comprising an array of a transmitting coil or coils and receiving coils, and a passive stylus with a magnetic material tip in such a manner that location of said stylus over a particular receiver coil not only improves the coupling of the receiver coil with a transmitting coil, but also significantly reduces coupling of neighbouring receiver coils with the transmitting coil or coils, thereby increasing signal-to-noise ratio and the ease with which stylus location may be determined.

FIG. 15 presents a stylus embodiment of the present invention in exemplary manner at 15.1. The stylus may be of an active or passive type, as is known in the art, and comprises a stylus body 15.2, an adjustable swivel joint 15.5 and a tip 15.4, and may be used on a surface 15.3, wherein the surface may contain sensors and electrodes to detect stylus position, data and commands. According to the present invention, stylus tip 15.4 may be arranged at an angle relative to stylus body 15.2, resulting in tip 15.4 being substantially orthogonal to surface 15.3 when the stylus body 15.2 is at a specific angle to said surface, which may improve the ease and accuracy of stylus detection. Specifically, it may prevent the so called hand-shadow effect caused when a user grips a stylus in a normal writing or drawing grip, with the stylus being at an angle to the sensing surface. Further, the present invention teaches that the angle between tip 15.4 and stylus body 15.2 may be reconfigurable, using adjustable swivel joint 15.5, which may be used by a user to configure said stylus to suit their particular grip or style.

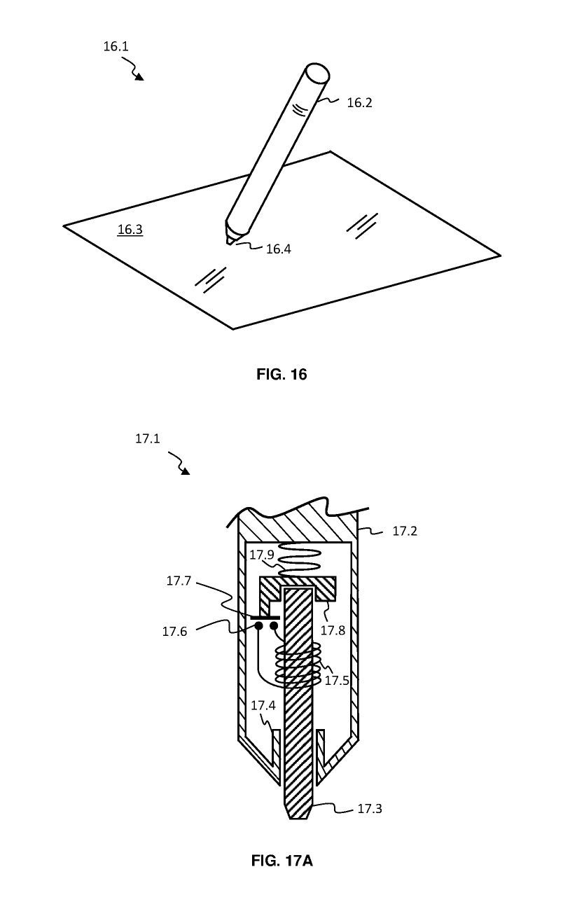

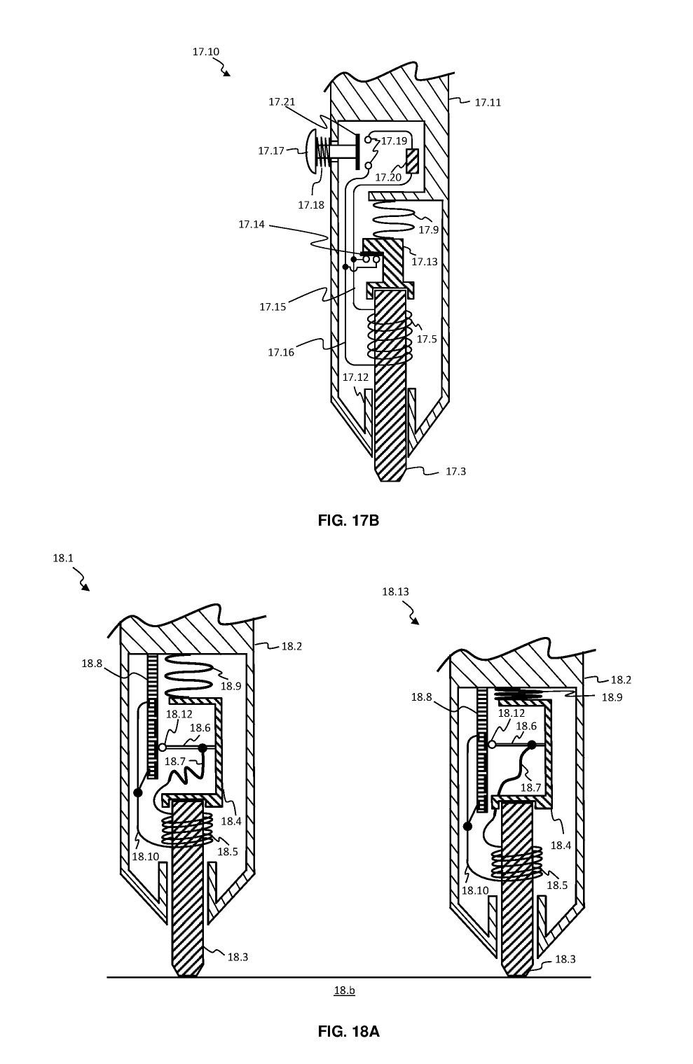

FIG. 16 depicts an exemplary passive stylus 16.2 which embodies the present invention at 16.1. Said stylus may comprise a magnetic material point 16.4, and may be used to indicate a specific position or path on a sensing surface 16.3, wherein said surface may utilize inductive sensing structures and circuitry (not shown) to detect the position and movement of point 16.4, similar to that described earlier during the present disclosure. The magnetic material may be ferrite, for example. However, according to the present invention, point 16.4 may be movable, and may move into the body of stylus 16.2 when pressed against sensing surface 16.3, and wherein a coil of conductive material may be wound around point 16.4 (not shown in FIG. 16) and used to detect movement of point 16.4 via selective short-circuiting of the coil. According to the present invention, when said coil is short-circuited, it may adversely affect coupling of another coil (not shown) with said magnetic material point, resulting in a measurable change in inductance for the other coil.

FIG. 17A presents details of the above described embodiment in a sectional view at 17.1. A passive stylus 17.2 may have a point or tip 17.3 fashioned out of magnetic material, for example out of ferrite, and may protrude from an opening or shaft 17.4 in one end of stylus 17.2. Point 17.3 may move along shaft 17.4 into or out of the stylus body when pressed against a surface (not shown), for example a sensing surface which contain a number of resonant transmitter and receiver coils or inductances used to determine and track the position of stylus 17.2. A conductive coil 17.5 may be wound around ferrite point 17.3. The two ends or terminals of coil 17.5, as shown at 17.6, may be connected together by conductive member 17.7 to short-circuit the coil. When coil 17.5 is short-circuited, it may adversely affect coupling and inductance of a coil or coils, or of an inductive structure or structures which are in proximity to ferrite point 17.3. Conductive member 17.7 may be attached to a mechanical coupling member 17.8, wherein the latter abuts or presses against ferrite point 17.3. A resilient member 17.9, for example a spring, may press against mechanical coupling member 17.8 and the body of stylus 17.2, as shown, and may return ferrite point 17.3 to a maximum extended position when said point is not pressed against a surface or other object. According to the present invention, when ferrite point 17.3 is not pressed, i.e. it is maximally extended, conductive member 17.7 may connect the terminals or ends 17.6 of coil 17.5, i.e. it may short-circuit the coil. Once point 17.3 is pressed with sufficient force or pressure against a surface, for example a sensing surface, to move a specific distance into the body of stylus 17.2, thereby causing member 17.8 to also move said distance, or a related distance, conductive member 17.7 may move away from coil terminals 17.6, resulting in coil 17.5 becoming open-circuit. The transition from short-circuit to open-circuit by coil 17.5 may be detected from measured inductance values of other coils or inductive structures in proximity to ferrite point 17.3. This may allow determination of the position of stylus 17.2 on said surface.

FIG. 17B depicts an alternative exemplary embodiment to that of FIG. 17A, with like reference numerals referring to like members. A passive stylus 17.11 is shown at 17.10, with the addition of a side push button 17.17. The structure and operation of stylus 17.11 will be described in exemplary manner. Similar to before, a magnetic material point 17.3, for example a ferrite point, protrudes from a shaft 17.12 in the body of stylus 17.11, with a conductive coil 17.5 wound around ferrite point 17.3. A mechanical coupling member 17.13 abuts against ferrite point 17.3 and also presses against resilient member 17.9. The latter may be used to return ferrite point 17.3 to a maximally extended position when said point is not pressed against a surface or object, similar to before. During this state a conductive member 17.14 may connect the two ends 17.15 and 17.16 of coil 17.5 together to short-circuit said coil, as before. When point 17.3 is pressed with sufficient force to cause it to move a specific distance conductive member 17.14 may break contact with the coil ends, resulting in coil 17.5 becoming open-circuit. In addition, a push button 17.17 may be located in the side of, or elsewhere on, stylus 17.11 where it may be easily engaged by a user of the stylus. Push button 17.17 may be supported by resilient member 17.18, which may be a spring, for example. The position of member 17.18 need not be as shown. A conductive member 17.21 may be attached to push button 17.17. When a user presses push button 17.17 with sufficient force, conductive member 17.21 may make contact with, and connect terminals 17.19 of coil 17.5 via a resistance 17.20 as shown. The latter may also have a resistance of zero Ohm. In this manner, a user may press stylus 17.11 with a sufficient first amount of force or pressure against a sensing surface (not shown) to cause conductive member 17.14 to move away from coil ends 17.15 and 17.16, causing coil 17.5 to become open-circuit, with the resultant change in inductance of an associated coil or coils (not shown) which may then be used to determine the position of stylus 17.11 on the sensing surface and track its movement. A user may then use push button 17.17 to short-circuit coil 17.5 again while continuing to press stylus 17.11 with said first amount of force or pressure. Alternatively, pressing button 17.17 may result in a specific resistance connected across the terminals of coil 17.5, as described. Detection by the sensing surface (not shown) and associated circuitry (not shown) of activation or pressing of push button 17.17 by a user while maintaining said first amount of pressure or force on stylus 17.11 may be used to discern specific user commands. For example it may be used to emulate a tap of the stylus. Or it may be used to change a line width or colour without lifting said stylus off said sensing surface, and so forth.

Yet another exemplary passive stylus embodiment is shown at 18.1 and 18.13 in FIG. 18A, with similarities to the described embodiments in the preceding. A passive stylus 18.2 is shown at 18.1, with a magnetic material point 18.3 which may contact a sensing surface 18.b. The latter may comprise inductive structures and measurement circuitry to detect the position and movement of stylus 18.2. The magnetic material point 18.3 may be fashioned out of ferrite, for example, and may move into the body of stylus 18.2 via a shaft or opening in one end, as shown. Ferrite point 18.3 may press against mechanical coupling member 18.4, which in turn may press against resilient member 18.9, which may be a spring, for example. As before, resilient member 18.9 may return point 18.3 to a maximum extended position when said point is not pressed against a surface or object. A conductive coil 18.5 may be wound around ferrite point 18.3, similar to before. One end 18.10 of said coil may be connected to two pads or connections of a PCB 18.8, or to another substrate or structure, as shown. The other end of coil 18.5 may be connected to the support member 18.6 of an electrical contact 18.12 which may engage PCB 8.8, wherein said connection to member 18.6 may be via a flexible interconnect or cable 18.7. Support member 18.6 may be fashioned such that allows contact 18.12 to engage PCB 8.8 in a spring loaded manner, in an effort to ensure a proper electrical connection. PCB 8.8 may contain a number of resistances, allowing different resistance values to be connected across coil 17.5 dependent on the amount of pressure or force applied to ferrite point 18.3. For example, for the situation depicted at 18.1, point 18.3 is pressed with sufficient force against sensing surface 18.b to cause electrical contact 18.12 to move upwards along PCB 18.8 to contact a second pad or connection, as shown. This may result in coil 18.5 not being short-circuited anymore, but having a first resistance value connected across its ends. Correspondingly when point 18.3 is pressed with enough force or pressure against sensing surface 18.b to move said point to a maximum retracted position, the situation as depicted in exemplary manner at 18.13 may result, wherein resilient member 18.9 may be fully depressed and contact 18.12 may be connected to a last pad or connection of PCB 8.8. As such, coil 18.5 may be connected across a final resistance value, or it may be short-circuited again.

To better clarify the variable resistance embodiment of FIG. 18A, two detailed, but exemplary, views of PCB 18.8 is presented at 18.14 and 18.15 in FIG. 18B respectively, with like reference numerals representing like members. The improve clarity, not all reference numerals displayed at 18.14 is repeated at 18.15, although they still apply to identical entities. As shown, PCB 18.8 may comprise two layers, for example a top and bottom layer, with pads 18.18, 18.20, 18.22, 18.23, 18.24 and 18.25 being on one layer, and pads 18.17, 18.19, 18.30, 18.31, 18.32 and 18.33 on the other layer. Via's such as shown at 18.21 may be used to connect a number of the pads together. For example, pads 18.17 and 18.18 may be connected with a via as shown, pads 18.25 and 18.30 may be connected together with a via as shown, pads 18.24 and 18.31 may connected together with a via as shown, pads 18.23 and 18.32 may be connected together with a via as shown, pads 18.22 and 18.33 may be connected together with a via as shown and pads 18.19 and 18.20 may be connected together with a via as shown. In addition, a number of resistors may be connected to various pads on the one layer. Typically, solder joints as shown at 18.34 may be used to attach a resistor to a particular pad, as is known in the art. Resistor 18.26 may be connected between pads 18.20 and 18.31, resistor 18.27 may be connected between pads 18.31 and 18.32, resistor 18.28 may be connected between pads 18.32 and 18.33 and resistor 18.29 may be connected between pads 18.33 and 18.19, as depicted in FIG. 18B. As is evident from the FIG. 18B, one end of coil 18.5 may be connected to pads 18.17 and 18.19 via interconnect 18.10, while the other end of said coil may be connected via flexible interconnect or cable 18.7 to support member 18.6 of electrical contact 18.12, wherein said contact may engage one of pads 18.17, 18.20, 18.22, 18.23, 18.24 or 18.25. When the ferrite point member (not shown) of the passive stylus (not shown) moves such that electrical contact 18.12 engages pad 18.18, or the first pad, coil 18.5 is effectively short circuited, since pads 18.18 and 18.17 are connected by a via. Similarly, when said ferrite point (not shown) moves such that contact 18.12 engages pad 18.25, as shown in FIG. 18B, the two ends of coil 18.5 are connected via resistors 18.26, 18.27, 18.28 and 18.29. When contact 18.12 engages pad 18.24, only resistors 18.27, 18.28 and 18.29 are connected across coil 18.5. When contact 18.12 engages pad 18.23, only resistors 18.28 and 18.29 are connected across coil 18.5. And when contact 18.12 engages pad 18.22, only resistor 18.29 is connected across coil 18.5. In this manner, according to the present invention, a range of resistor values may be connected across coil 18.5, dependent on the position of electrical contact 18.12 and support member 18.6 (and therefore also the position of the stylus ferrite point, as described earlier)

Lastly, when electrical contact 18.12 engages pad 18.20, as depicted at 18.15 in FIG. 18B, coil 18.5 is again short-circuited, since pad 18.20 is connected to pad 18.19 by via 18.21, and pad 18.19 is connected via interconnect 18.10 to the other end of coil 18.5.

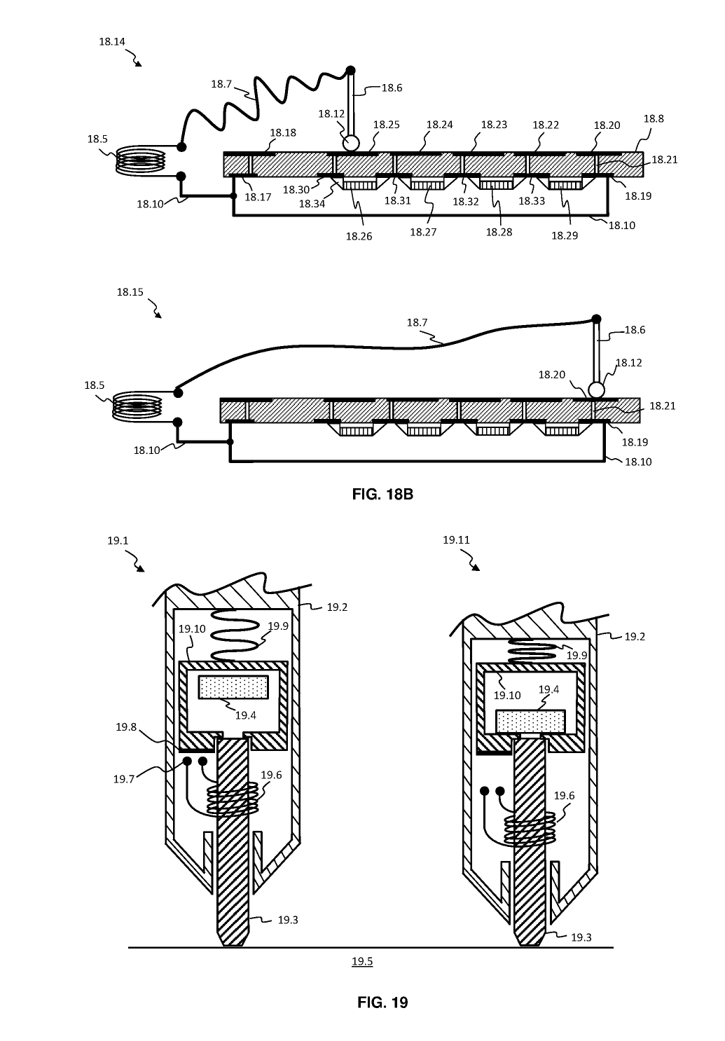

FIG. 19 presents another exemplary embodiment of the present invention at 19.1 and 19.11, whereby both contact of a stylus point on a sensing surface as well as a relative pressure value applied by the stylus may be detected. For example, a passive stylus 19.2 may have a point member 19.3 fashioned out of a magnetic material such as ferrite which may move within a shaft in the stylus housing, similar to that disclosed in the preceding. Ferrite point member 19.3 may engage or make contact with a sensing surface 19.5, wherein said surface may contain inductive structures and associated circuitry which may be used to determine the position and movement of said stylus point. A conductive coil 19.6 may be wound around ferrite point member 19.3. A mechanical coupling member 19.10 may abut against the ferrite point member 19.3, with a resilient member 19.9, for example a spring, pressing against both said coupling member and the housing of the stylus, as before. A conductive member 19.8 may be attached to coupling member 19.10, or the whole coupling member may be fashioned out of conductive material, and may be used to connect the two ends of coil 19.6 together, i.e. short-circuiting the coil. A magnetic flux altering member 19.4 may be fixedly mounted to the body of stylus 19.2 and may be located within the path of magnetic flux emanating from magnetic point member 19.3. An air-gap of a first length may exist between the one end of point member 19.3 and said magnetic flux altering member 19.4 when the point member is not pressed against a surface or object, i.e. it is in a maximally extended position.

As shown at 19.1, when the stylus is pressed with a first amount of sufficient force or pressure against sensing surface 19.5, conductive member 19.8 may move sufficiently away from coil terminals 19.7 to remove the short-circuit over the coil, which may cause a significant change in the measured inductance of an inductive structure (not shown) in surface 19.5. In addition, the air-gap between flux altering member 19.4 and magnetic point 19.3 may have decreased, that is point 19.3 may have moved closer to member 19.4. Point 19.3 may continue to move into the body of stylus 19.2 as more pressure is applied, and come closer to flux altering member 19.4 until the situation depicted at 19.11 is reached, where point member 19.3 is pressed against member 19.4, with said air-gap being at a minimum. According to the present invention, the decreasing air-gap length and the associated increased influence of flux-altering member 19.4 on the flux of ferrite point 19.3 may be used to determine the relative pressure with which stylus 19.2 is pressed against sensing surface 19.5.

A number of operation states for stylus 19.2 may be detected in this manner. In a first operational state the stylus is not in contact with said sensing surface 19.5, and coil 19.6 is short-circuited by conductive member 19.8, adversely affecting coupling of point 19.3 with an inductive structure (not shown) in said sensing surface. In a second operational state, the stylus is in contact with sensing surface 19.5 and pressed with just enough force or pressure to remove the short-circuit across coil 19.6, which may be detected as a significant change in the measured inductance of said inductive structure. In a third operational state, ferrite point 19.3 moves continually closer to flux altering member 19.4 as more pressure is applied by the stylus to said sensing surface, which may cause a corresponding change in the measured inductance of said inductive structure. In a fourth operational state, ferrite point 19.3 is pressed as far as it can go into the body of stylus 19.2, with said air-gap at a minimum, as depicted in exemplary manner at 19.11 in FIG. 19. As such, the flux-altering member 19.4 may have a maximum effect on the magnetic flux from ferrite point 19.3, which may allow detection of the fourth operational state.

According to the present invention, flux altering member 19.4 may be fashioned out of either magnetic material or conductive material. When fashioned out of magnetic material, it may improve coupling of ferrite point 19.3 with an inductive structure, wherein the amount of improvement may be dependent on the length of said air-gap, i.e. how far member 19.4 is from point member 19.3. Conversely, when member 19.4 is fashioned out of conductive material, it may cause eddy current losses, which may negatively affect measured inductance of an inductive structure magnetically coupled to ferrite point 19.3, wherein said air-gap length may proportionally influence the amount of eddy-current loading experience by said inductive structure.

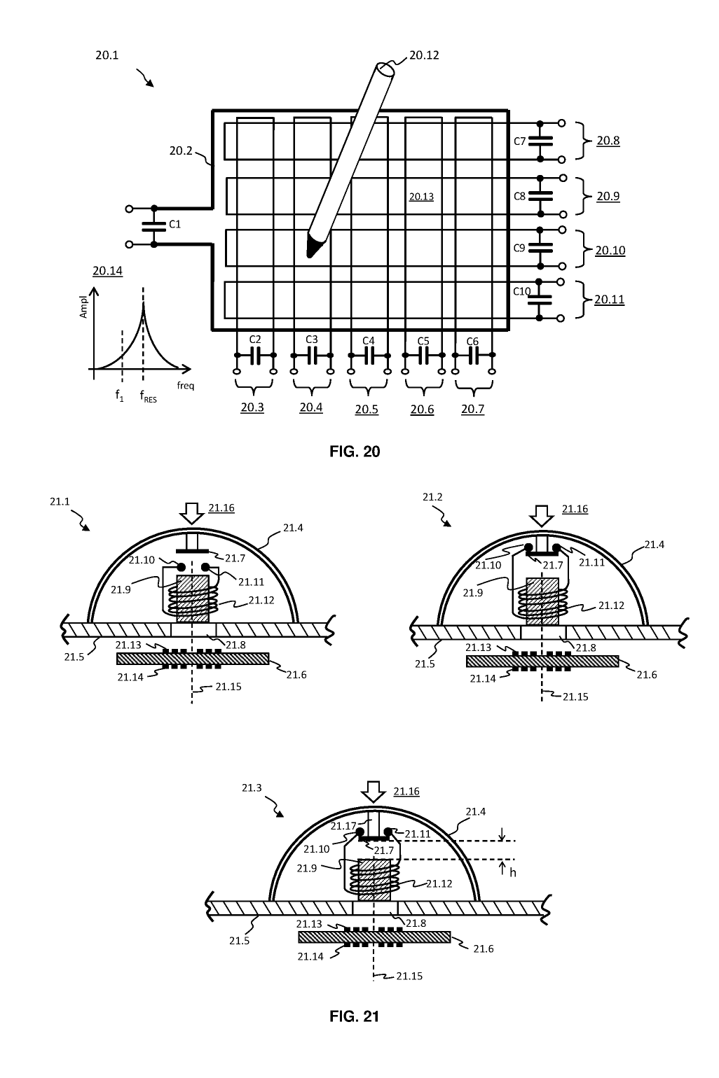

FIG. 20 depicts a passive stylus embodiment of the present invention in exemplary manner at 20.1. A transmitter coil 20.2 may be used in conjunction with receiver coils 20.3 to 20.11 to detect the position and movement of a passive stylus 20.12, wherein said stylus may have a magnetic tip or point, for example a ferrite point. Transmitter coil 20.2 may be connected to a resonant capacitor C1 as shown, with C1 calculated to result in a resonance frequency of f_{RES}, as shown at 20.14. Each of the receiver coils 20.3 to 20.11 may also be connected to resonant capacitors C2 to C10 respectively, as shown, wherein each receiver coil and capacitor combination, for example coil 20.3 and capacitor C2, coil 20.4 and capacitor C3 and so forth, calculated to also result in a resonance frequency of f_{RES}. However, when transmit coil 20.2 is driven by a signal source (not shown) at said resonant frequency f_{RES}, the present inventors have observed that multiple resonant frequencies are established for said receiver coils, possibly due to a large amount of cross-coupling. In other words, each receiver coil and capacitor combination does not resonate at f_{RES} as expected. This significantly increases the amount of effort required to detect the position and movement of stylus 20.12 from inductance measurements of the receiver coils. Therefore, the present invention teaches that transmitter coil 20.2 may be driven at a frequency f₁ slightly below or above the calculated theoretical resonant frequency f_{RES}, which may allow stable measurement results to be obtained from each of the receiver coils by reducing the detrimental impact of multiple resonant points, to detect the position and movement of stylus 20.12. Frequency f₁ is illustrated at 20.14 as being slightly lower than the calculated or theoretical frequency f_{RES}. According to the present invention, capacitors C1 to C10 may still be required even if transmitter coil 20.2 is driven at frequency f₁, as it has been observed that removal of said capacitors leads to a significant decrease in signal-to-noise ratios.

In an alternative embodiment, each of the receiver coil capacitors C2 to C10 may be connected via controllable switches (not shown) to each coil, wherein the switches are normally-open and only closed to connect a particular capacitor to its receiver coil when said coil is measured. This may allow transmitter coil 20.2 to be driven at the calculated resonant frequency f_{RES}, as only a single receiver coil and resonant capacitor combination should couple to the transmitter coil at any given instant, with a single resonant frequency, allowing stable measurements.

It is to be appreciated that although a fair number of the preceding disclosed stylus embodiments are directed at passive styli, the present invention need not be limited in this regard, with application and practise of the teachings of the invention for active styli falling within the scope and potential claims of the present invention.

Selective short-circuiting of a magnetic member may also be advantageously used in push-button applications across sealed surfaces, according to the present invention. FIG. 21 presents exemplary embodiments of this teaching in cross-sectional views at 21.1, 21.2 and 21.3. A sealed surface or substrate 21.5 may be located over an inductive structure such as 21.13 and 21.14, which may be a planar inductor on both sides of PCB 21.6. Naturally, the inductive structure is not limited to planar inductors or coils, or to the use of double sided PCB's. Planar inductor 21.13/21.14 may have a magnetic axis 21.15. Sealed surface 21.5 may be fashioned out of material which is permeable to magnetic fields, such as plastic, or it may be fashioned out of conductive material, for example aluminium, with a hole 21.8 formed in said surface and aligned with magnetic axis 21.15 of planar inductor 21.13/21.14. To maintain sealing, hole 21.8 may be filled with the one or other material, for example epoxy, which is permeable to magnetic fields. Alternatively, sealed surface 21.5 may be fashioned from a conductive material without a hole formed in it, but wherein the frequency of inductance measurements is sufficiently low that the thickness of said sealed surface is significantly thinner than the skin-depth at said frequency.

A magnetic member 21.9, for example a ferrite core, may be situated on the opposite side of sealed surface 21.5, as shown, and may be aligned with magnetic axis 21.15, with magnetic flux from planar inductor 21.13/21.14 which may couple with member 21.9. A coil 21.12 may be wound around ferrite core 21.9, wherein the terminals 21.10 and 21.11 of coil 21.12 may be short-circuited by conductive member 21.7. As shown, the latter may be attached to the apex of a dome structure 21.4, wherein the dome structure is resilient in nature, and may be fashioned out of any suitable material, for example plastic or metal. A user may depress dome structure 21.4 by expressing pressure or force in direction 21.16 to actuate the inventive push button structures disclosed. When conductive member 21.7 shorts-circuits coil 21.12 by connecting coil ends 21.10 and 21.11, coupling of magnetic member 21.9 with planar inductor 21.13/21.14 may be adversely affected, which may enable detection of the event from measurements of the inductance of planar inductor 21.13/21/14. Each of the push button variants depicted in exemplary manner at 21.1, 21.2 and 22.3 will next be described in detail.

In the push button structure shown at 21.1 in FIG. 21, coil 21.12 is normally in an open circuit configuration with conductive member 21.7 situated away from coil ends or terminals 21.10 and 21.11. When a user applies sufficient force or pressure to dome 21.4, it may deflect enough for conductive member to connect coil ends 21.10 and 21.11 to each other, thereby short-circuiting coil 21.12, which may adversely affect coupling of magnetic flux from planar inductor 21.13/21.14 with magnetic member 21.9. Therefore, a significant change in the measured inductance of said inductor should be discernible at the moment when coil 21.12 is short-circuited, which may allow accurate detection of push button actuation.

For the exemplary push button structure presented at 21.2 in FIG. 21, coil 21.12 is normally in a short-circuit configuration, with conductive member 21.7 nominally connecting coil ends 21.10 and 21.11 to each other. As such, coupling of magnetic flux from planar inductor 21.13/21.14 may be adversely affected. When a user applies sufficient force or pressure to dome 21.4 in direction 21.16, it may deflect, causing conductive member to break contact with coil ends 21.10 and 21.11, thus removing said short-circuit. Accordingly, flux from planar inductor 21.13/21.14 may couple more effectively with magnetic member 21.9, resulting in a significant change in the measured inductance of planar inductor 21.13/21.14, from which the button actuation event may be discerned.

A characteristic of the embodiment shown at 21.2 is that the amount of travel by conductive member 21.7 in direction 21.16 may be limited by dome 21.4 clashing or pressing against terminals or contacts 21.10 and 21.11. If dome 21.4 is made out of conductive material, this may reinstate said short-circuit across coil 21.12. Whether this is advantageous and useful, or a drawback may depend on the application for the push button structure. However, the situation may be avoided to some extent by increasing the length of member 21.17 used to attach conductive member 21.7 to the apex of said dome, as shown at 21.3 in FIG. 21. Advantageously, if the length of member 21.17 is dimensioned correctly, it may be possible to realize a push button structure which allows tri-state operation across sealed surface 21.5. For example, for the embodiment depicted at 21.3, when a user applies a first amount or pressure or force in direction 21.16 to dome 21.4, it may deflect slightly but sufficiently to break contact between conductive member 21.7 and terminals 21.10 and 21.11, thereby removing the short-circuit of coil 21.12, providing a discernible event in inductance measurements for planar coil 21.13/21/14, as described in the preceding. Hereafter, conductive member 21.7 may move over a distance h as shown due to the increased length of member 21.17. If a user applies sufficient pressure in direction 2.16 to dome 21.4, it may snap through, bringing conductive member 21.7 in close contact with ferrite core 21.9, which may cause significant and sudden eddy current loading of planar inductor 21.13/21.14, resulting in another discernible event in the measured inductance of said inductor. Therefore, three states may be discerned for the push button structure depicted at 21.3 in FIG. 21, namely a first state wherein dome 21.4 is not pressed, with coil 21.12 short-circuited, a second state wherein dome 21.4 is pressed just enough to remove said short-circuit, and a third state wherein dome 21.4 is pressed sufficiently to cause snap through, with conductive member 21.7 pressed against or coming in close proximity to magnetic member 21.9.

Further, the present invention teaches that an exemplary embodiment as shown at 21.3 may also be used to determine a relative amount of pressure applied to dome 21.4 as conductive member 21.7 moves over distance h, which may cause increased eddy current loading of planar inductor or coil 21.13/21.14. Alternatively, magnetic material may be attached to the bottom of conductive member 21.7, and may be used to increasingly influence magnetic flux passing through member 21.9 as dome 21.4 is pressed downwards.

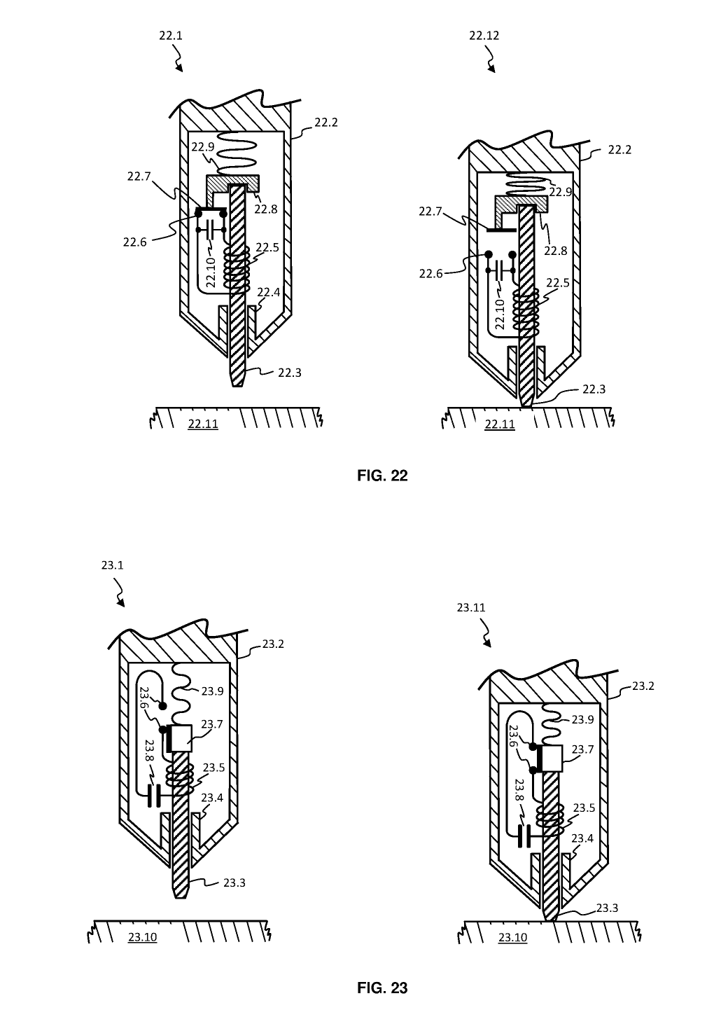

An exemplary stylus embodiment of the present invention is depicted at 22.1 and 22.12 in FIG. 22. At 22.1, the stylus 22.2 is not in contact with a surface 22.11. Said surface may contain a number of transmit and receive coils (not shown) to monitor and detect the presence, position and movement of the stylus, similar to that described elsewhere in the present disclosure. Charge transfer based circuitry (not shown) and methods or techniques may be used for said monitoring and detection. As shown, stylus 22.2 contains a stylus coil or inductor 22.5 wound around a stylus point member 22.3, wherein said point member may be fashioned out of a magnetic or non-magnetic material, for example it may be fashioned out of ferrite. Coil 22.5 is connected in parallel to a capacitor 22.10 to form a resonant pair which may resonate at a first resonant frequency. Energy received from a transmit coil (not shown) in surface 22.11 may cause said resonation. However, in the stylus state depicted at 22.1 a short-circuiting member 22.7 is connected across stylus coil 22.5 and stylus capacitor 22.10 via contacts 22.6, preventing or inhibiting said resonance. Member 22.7 may be held in place by coupling member 22.8 via the spring action or force of resilient member 22.9, as shown. Member 22.9 may be a metal or plastic spring, as examples.

When a user presses the stylus point 22.3 against surface 22.11 with sufficient force, point member 22.3 may move within shaft 22.4 and push coupling member in such a manner that short-circuiting element 22.7 moves away or breaks contact with contacts 22.6, as shown at 22.12 in FIG. 22. As a result, stylus coil 22.5 and capacitor 22.10 may resonate at said first resonant frequency with energy received from a transmit coil (not shown) in surface 22.11, enabling detecting and monitoring of the presence, position and/or movement of stylus 22.2.

FIG. 23 depicts an exemplary embodiment at 23.1 and 23.11 which is related to that of FIG. 22. At 23.1, a stylus 23.2 not in contact with surface 23.10 is shown, wherein stylus 23.2 comprises a point member 23.3, a guiding shaft 23.4, a stylus coil 23.5, contacts 23.6, a connecting member 23.7, a stylus capacitor 23.8 and a resilient member 23.9. Point member 23.3 may be fashioned out of magnetic or non-magnetic material, for example it may be fashioned out of ferrite, or out of plastic. Stylus coil or inductor 23.5 may be wound on or around point member 23.3. Resilient member 23.9 may be fashioned out of the one or other elastic material, for example it may be a metal spring, a plastic spring or a piece of rubber. Member 23.9 may be used to press connecting member 23.7 away from contacts 23.6, thereby inhibit or preventing the resonance of coil 23.5 and capacitor 23.8 at a first resonant frequency. Surface 23.10 may contain a number of transmit and receive coils (not shown) which may respectively be used to energize stylus 23.2 and to detect or monitor the presence, position and/or movement of said stylus. Said detection or monitoring may be performed by using charge transfer based measurement circuitry (not shown) and methods or techniques.

When a user presses stylus 23.2 with sufficient force or pressure against surface 23.10, point member 23.3 may push connecting member 23.7 far enough to cause connection of contacts 23.6, as shown at 23.11 in FIG. 23. As a result, coil 23.5 and capacitor 23.8 may resonate at said first resonant frequency with energy received from a transmit coil or coils (not shown) in surface 23.10, allowing detection and/or monitoring of the presence, position and/or movement of stylus 23.2 by said measurement circuitry (not shown) in surface 23.10.

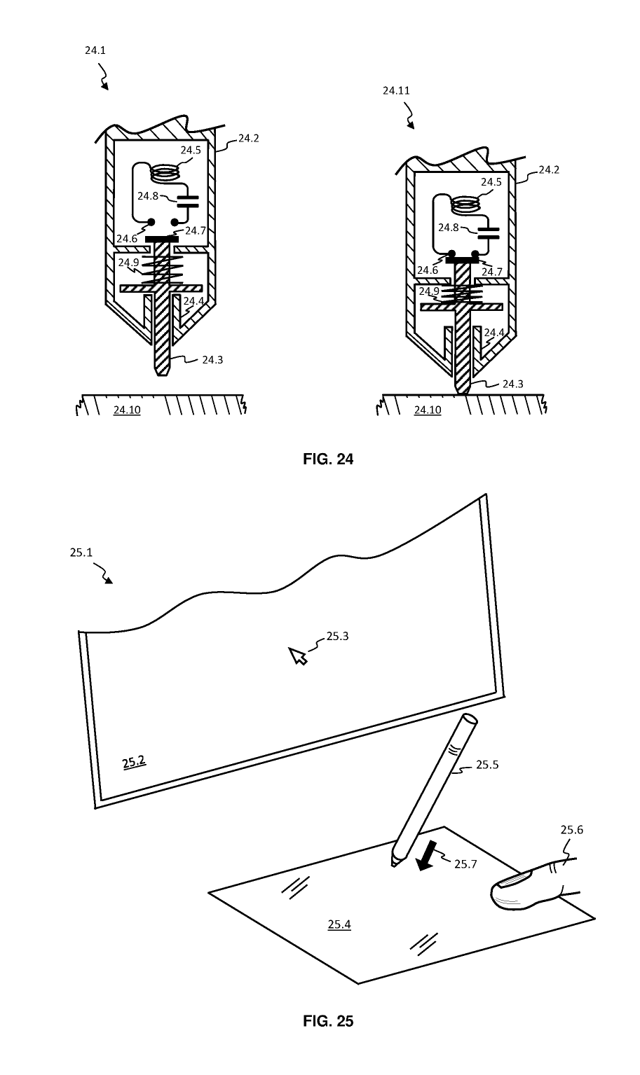

The stylus coil as described need not be wound around or on the stylus point member to practice the teachings of the present invention, but may be located distinctly from it within the stylus. FIG. 24 depicts such an embodiment in exemplary manner. Similar to before, stylus 24.2 comprises a point member 24.3, a guiding shaft 24.4, stylus coil 24.5 connected to a stylus capacitor 24.8, terminals 24.6, a connecting member 24.7 and a resilient member 24.9. The stylus may interact with a surface 24.10, wherein said surface may contain a number of transmit and receive coils or inductors (not shown), which may be used during monitoring and/or detection of the presence, position and/or movement of said stylus. Said monitoring and/or detection may be performed with charge transfer based measurement circuitry (not shown), and/or other circuitry (not shown). As depicted at 24.1 in FIG. 24, when stylus is not pressed against surface 24.10, resilient member 24.9 may push point member 24.3 outwards, with connecting member 24.7 not making electrical contact with terminals 24.6. Resilient member 24.9 may be a metal spring, a plastic spring or an elastic rubber, as examples. Correspondingly, with connecting member 24.7 not making contact with terminals 24.6, the current path through stylus coil 24.5 and stylus capacitor 24.8 is not closed, and resonance at a first resonant frequency should not take place. It is to be noted that in the embodiment of FIG. 24, stylus coil 24.5 is not wound around point member 24.3, and is located away from it. The depicted location of the stylus coil is purely exemplary, and it may be located anywhere on or in the body of stylus 24.2. Point member may be fashioned from any magnetic or non-magnetic material. In a preferred embodiment, it is fashioned out of plastic.

The embodiment shown at 24.11 may result when a user presses stylus against surface 24.10 with sufficient force or pressure to cause point member 24.3 to move into the body of the stylus until connecting member 24.7 electrically connects terminals 24.6. In this state, the current path through stylus coil 24.5 and capacitor 24.8 is closed, and said coil and capacitor may resonate at a first resonant frequency with energy received from a transmit coil or coils (not shown) in surface 24.10, allowing detection or monitoring of stylus presence, position and/or movement, similar to that described before, and thus omitted for brevity's sake.

If a trackpad, touchscreen or other device can simultaneously detect both user finger touch gestures or actions and stylus gestures or actions, a number of advantageous UI methods or gestures may be realized. An exemplary embodiment which utilizes such a trackpad is depicted at 25.1 in FIG. 25, wherein trackpad 25.4 and associated circuitry (not shown) may simultaneously, or nearly simultaneously, detect the presence, position and/or movement of both stylus 25.5 and user finger 25.6. As an example, stylus 25.5 may be a passive stylus or a resonant stylus similar to that described elsewhere in the present disclosure, and trackpad 25.4 may utilize charge transfer based inductance measurement circuitry and methods to monitor and detect the presence, position and/or movement of stylus 25.5. Further, trackpad 25.4 may e.g. detect proximity or touch by user finger 25.6 using the same or other charge transfer based measurement circuitry to perform capacitive sensing measurements. Trackpad 25.4 may also, as a further example, use the same or different conductors or electrodes to sense or monitor both stylus 25.5 and finger 25.6.

According to the present invention, when a user presses stylus 25.5 in direction 25.7 against trackpad 25.4 to make either contact, or to exceed a predetermined threshold of pressure or force, associated circuitry (not shown) may start a cursor repositioning gesture. Said user may then use his/her finger 25.6 to engage trackpad or touchpad 25.4, and thereby move or change the position of a cursor 25.3 displayed on an associated display 25.2. As an example, finger 25.6 may reposition cursor 25.3 via proximity or touch actions for as long as stylus 25.5 contacts or is pressed with sufficient force or pressure against trackpad 25.4. When stylus 25.5 ceases to engage trackpad 25.4, the position of cursor 25.3 may be locked or set, where-after the stylus may be used for other functions such as inking or item selection.

The above stylus and touch gesture need not be limited to stylus 25.5 which needs to be pressed against or make contact with trackpad 25.4. For example, in another embodiment, the stylus may only be activated, with said activation sensed by trackpad 25.4 or other circuitry (not shown), where-after the user may reposition cursor 25.3 on display 25.2 using his/her finger 25.6 to engage the trackpad via either proximity or touch. The user may set or lock the position of cursor 25.3 in a number of ways, e.g. it may tap or double tap on trackpad 25.4 with either stylus 25.5 or finger 25.6, or it may deactivate and reactivate said stylus and so forth. In the case of a passive or resonant stylus similar to those described earlier during the present invention, said activation may comprise closing or opening a switch in the stylus to allow or inhibit current flow in a coil, or current flow in a resonant circuit, as the case may be.

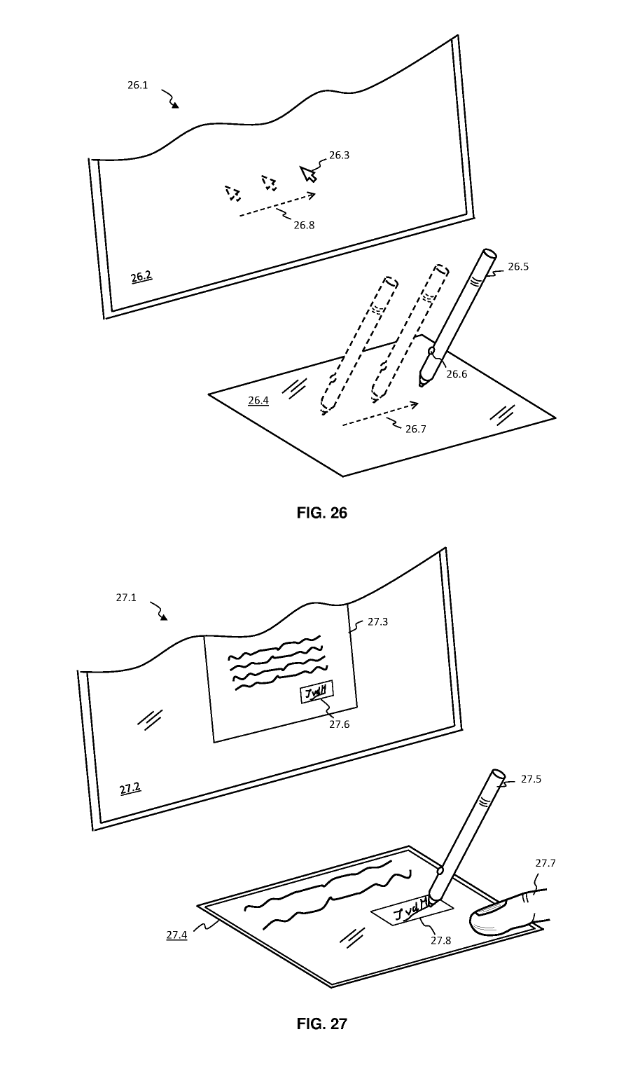

Another stylus gesture embodiment is depicted in exemplary manner at 26.1 in FIG. 26. A stylus 26.5 may be used to engage a trackpad 26.4, wherein said stylus may be a passive or resonant type similar to that described elsewhere in the present disclosure. Trackpad 26.4 and associated circuitry (not shown) may utilize charge transfer inductance measurement circuitry and methods to monitor or detect the presence, position and movement of stylus 26.5. In addition, stylus 26.5 may also have a side-switch or button 26.6, wherein circuitry (not shown) associated with trackpad 26.4 or other circuitry may detect the activation of switch 26.6. According to the present invention, a user may reposition a cursor 26.3 displayed on an associated display 26.2 using stylus 26.5 without drawing a line on said display in the following manner. Stylus 26.5 may be pressed against trackpad 26.4 with a predetermined amount of sufficient force, or with just enough force to make contact. Side-switch 26.6 may be pressed while maintaining said force or contact and moving the stylus in a direction 26.7 as depicted, to result in cursor 26.3 on display 26.2 which also moves in an corresponding direction 26.8 on the display. Once stylus 26.5 stops moving, and switch 26.6 is released, the position of cursor 26.3 may be set or locked.

FIG. 27 depicts yet another stylus and touch gesture embodiment of the present invention in exemplary manner at 27.1. In this embodiment, the trackpad 27.4 may also function as a secondary display to replicate content or parts of content displayed on primary display 27.2, in addition to sensing the presence, position and/or movement of stylus 27.5 and user finger 27.7. Trackpad 27.4 may, for example, comprise a number of transmit and receive coils (not shown), which may be used with charge transfer inductance measurement circuitry (not shown) to monitor and detect stylus 27.5, which may be a passive stylus or a resonant stylus similar to that described elsewhere in the present disclosure. Trackpad 27.4 may further utilize charge transfer based circuitry (not shown) to detect proximity or touch of user finger 27.7, or it may use other circuitry and methods. According to the present invention, an embodiment as depicted may find multiple advantageous uses. For example, when a document 27.3 which requires signing in a signature box 27.6 is displayed on primary display 27.2, the trackpad may replicate only part of said document, and specifically a replica 27.8 of the signature box. A user may reposition the replicated content displayed on trackpad 27.4 with his/her finger 27.7 until a convenient position is reached, where-after stylus 27.5 may be used to sign in said signature box. As an example, once signing is complete, the user may lift his/her finger 27.7 from trackpad 27.4, which may result in the replicated content not being displayed on said trackpad anymore. As another example, to replicate selected content on trackpad 27.4, a user may first use stylus 27.5 or finger 27.7 to reposition a cursor on display 27.2 in a manner similar to that described earlier in the present disclosure, or in any other relevant manner. A specific user interaction may then be performed on or in the vicinity of said cursor using trackpad 27.4, for example a double tap with stylus 27.5, or depressing a stylus side-switch to cause content in the vicinity of the cursor on display 27.2 to be replicated on the display of trackpad 27.4. The present invention need not be limited in the size of the display of trackpad 27.4, and said display may comprise the whole trackpad surface area, or only part of it.

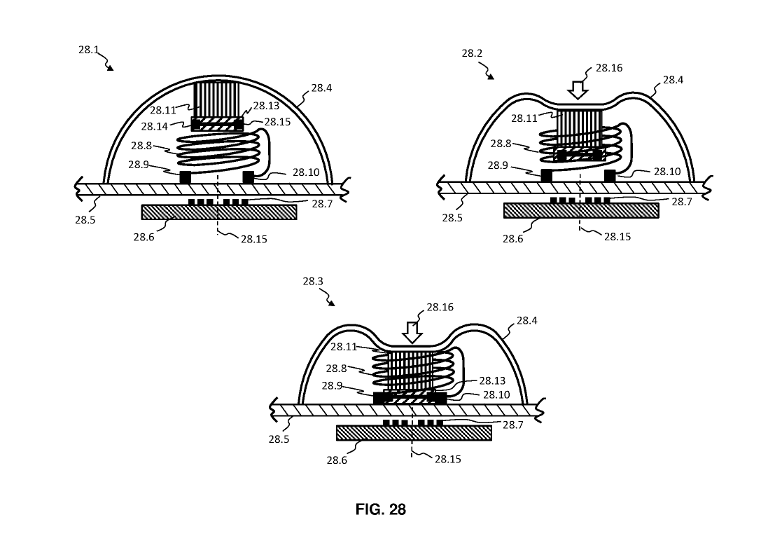

FIG. 28 presents yet another exemplary tri-state push-button embodiment of the present invention in an unactuated stated at 28.1, a first actuated state at 28.2 and a second actuated state at 28.3. Said push-button may comprise a flexible dome structure 28.4, from e.g. plastic, rubber or metal, a magnetic member 28.11 fashioned from ferrite, e.g., and fixed to the apex or near the apex of said dome, a first coil or inductive structure 28.8 on one side of a substrate 28.5, a second coil or inductive structure 28.7 on the other side of said substrate and a shorting member carrier 28.13. As shown, first coil 28.8 may nominally be in an open-circuit state, with terminals 28.9 and 28.10 unconnected. Further, second coil 28.7 may be formed on a substrate 28.6, for example a printed circuit board (PCB), and it's magnetic axis 28.15 may be aligned with that of first coil 28.8. Shorting member carrier 28.13 may also be fashioned out of PCB material, e.g., and may include two contacts 28.14 and 28.15 connected together as shown.

In an unactuated state as shown at 28.1 in FIG. 28, the dome is not pressed, and magnetic member 28.11 may be located at a maximum distance from second coil 28.7. Accordingly, the inductance of coil 28.7, as measured by e.g. a charge transfer based measurement circuit (not shown) may be at a first value, which may be a minimum value. For the unactuated state depicted at 28.1, said first coil 28.8 is in an open circuit state, and should have no or minimal effect on the measured inductance of second coil 28.7.

In a first actuated state, as presented in exemplary manner at 28.2, a user may apply a first amount of pressure or force in direction 28.16 to dome 28.4, which may cause deflection of the dome as shown. In a typical embodiment of the present invention, dome 28.4 need not be in a snapped-through state, as is known in the art, during said first actuated state, but may only be depressed a first, limited amount. Accordingly, magnetic member 28.11 may move closer to second coil 28.7, which may result in an increase in the measurement inductance of coil 28.7, from which the first actuation state may be discerned. Since first coil 28.8 is in an open-circuit state during the first actuated state depicted at 28.2, it should have a negligible effect on the measured inductance value of second coil 28.7.

When a user applies more than a first amount of pressure or force in direction 28.16 to dome 28.4, for example said user applies more than a specific threshold of force or pressure to the dome, it may snap-though, causing a second actuated state as shown at 28.3 in FIG. 28. As a result, magnetic member 28.11 may move substantially closer to second coil 28.7 and allow shorting member carrier 28.13 to connect the two terminals 28.9 and 28.10 of coil 28.8 together via contacts 28.14 and 28.15 (as marked at 28.1). The short-circuiting of coil 28.8 may cause a substantial change in the measured inductance value of coil 28.7, for example it may decrease it to a minimum value, wherein said change may be used to discern the second actuated state.

All of the preceding in the present disclosure is presented to clarify the invention at hand to enable a person of ordinary skill in the relevant arts to practise the teachings of the invention, and not to limit the scope of the invention. As such, terms should be used within context and interpreted to also imply reasonable use of their synonyms or equivalents. A number of alternative embodiments in addition to the exemplary embodiments described herein may exist. The scope of the invention is defined by the appended claims and interpretation thereof.

1. A trackpad for a dual user interface comprising capacitive sensing and inductive sensing capabilities, charge transfer measurement circuitry, a set of a plurality of sensing electrode structures, a set of a plurality of inductive receiving coils and at least one inductive transmit coil, wherein said set of sensing electrode structures is used with said charge transfer measurement circuitry for capacitive sensing, said capacitive sensing used to discern user input via finger proximity or touch, and wherein said set of inductive receiving coils is used with said charge transfer measurement circuitry for inductive sensing, said inductive sensing used to discern user input via a stylus.

2. The trackpad of claim 1, wherein said stylus comprises a spring-loaded mechanism which allow said charge transfer measurement circuitry to detect once the stylus contacts the trackpad with more than a first amount of pressure, wherein the spring-loaded mechanism removes a short-circuiting member across a capacitor in said stylus once said stylus contacts said trackpad with more than the first amount of pressure, wherein said capacitor forms a resonant pair with an inductive coil in the stylus, and wherein said removal enables energy exchange between said capacitor and said coil in the stylus, with the energy received from the one or more inductive transmit coils embedded in said trackpad.

3. The trackpad of claim 2, wherein said inductive coil in the stylus is wound around a magnetic member.

4. The trackpad of claim 3, wherein said magnetic member is mechanically coupled to a point member of said stylus.

5. The trackpad of claim 4, wherein said magnetic member is mechanically coupled to said spring-loaded mechanism.

6. The trackpad of claim 1, wherein said stylus comprises a spring-loaded mechanism which allow said charge transfer measurement circuitry to detect once the stylus contacts the trackpad with more than a first amount of pressure, wherein the spring-loaded mechanism connects a capacitor and an inductive coil in the stylus together once said stylus contacts said trackpad with more than the first amount of pressure, wherein said capacitor and said coil in the stylus form a resonant pair and exchanges energy with each other, with the energy received from the one or more inductive transmit coils embedded in said trackpad.

7. The trackpad of claim 6, wherein said inductive coil in the stylus is wound around a magnetic member.

8. The trackpad of claim 7, wherein said magnetic member is mechanically coupled to a point member of said stylus.

9. The trackpad of claim 8, wherein said magnetic member is mechanically coupled to said spring-loaded mechanism.

10. The trackpad of claim 1, wherein said at least one inductive transmit coil is connected in parallel with a capacitor, said inductive transmit coil and capacitor having a calculated first resonant frequency, and wherein each of the plurality of inductive receiving coils is connected in parallel with a distinct capacitor, with each pair formed by one of said inductive receiving coils and one of said distinct capacitors also having the first resonant frequency as their calculated resonant frequency, and wherein said at least one inductive transmit coil is driven at a frequency near, but not at, said first resonant frequency.

11. The trackpad of claim 1, wherein said stylus comprises a spring-loaded mechanism which allow said charge transfer measurement circuitry to detect once the stylus contacts the trackpad with more than a first amount of pressure, wherein the spring-loaded mechanism connects two ends of an inductive coil in said stylus together once said stylus contacts said trackpad with more than the first amount of pressure, said connection adversely affecting values measured by said charge transfer circuitry for said set of inductive receiving coils.

12. A trackpad method for a dual user interface, said trackpad comprising capacitive sensing and inductive sensing capabilities, charge transfer measurement circuitry, a set of a plurality of sensing electrode structures, a set of a plurality of inductive receiving coils and at least one inductive transmit coil, said method comprising the steps of:
using the charge transfer measurement circuitry to perform capacitive sensing with the set of sensing electrode structures;
using said capacitive sensing to discern user input via finger proximity or touch;
using the charge transfer measurement circuitry to perform inductive sensing with the set of inductive receiving coils;
using said inductive sensing to discern user input via a stylus.

13. The method of claim 12 further comprising a step of using a spring-loaded mechanism in the stylus to allow said charge transfer measurement circuitry to detect once the stylus contacts the trackpad with more than a first amount of pressure, wherein the step of using said spring-loaded mechanism comprises removal of a short-circuiting member across a capacitor in said stylus once said stylus contacts said trackpad with more than the first amount of pressure, wherein said capacitor forms a resonant pair with an inductive coil in the stylus, and wherein said removal enables energy exchange between said capacitor and said coil in the stylus, with the energy received from the one or more inductive transmit coils embedded in said trackpad.

14. The method of claim 12, further comprising the step of using a spring-loaded mechanism in the stylus to allow said charge transfer measurement circuitry to detect once the stylus contacts the trackpad with more than a first amount of pressure, wherein the step of using said spring-loaded mechanism comprises the connection of a capacitor and an inductive coil in the stylus together once said stylus contacts said trackpad with more than the first amount of pressure, wherein said capacitor and said coil in the stylus form a resonant pair and exchanges energy with each other, with the energy received from the one or more inductive transmit coils embedded in said trackpad.

15. The method of claim 12, further comprising the step of using a spring-loaded mechanism in the stylus to allow said charge transfer measurement circuitry to detect once the stylus contacts the trackpad with more than a first amount of pressure, wherein the step of using said spring-loaded mechanism comprises the connection of two ends of an inductive coil in said stylus together once said stylus contacts said trackpad with more than the first amount of pressure, said connection adversely affecting values measured by said charge transfer circuitry for said set of inductive receiving coils.

16. The method of claim 12, wherein said method comprises the additional steps of connecting the at least one inductive transmit coil in parallel with a capacitor, wherein the inductive transmit coil and capacitor pair have a calculated first resonant frequency, of connecting each of said plurality of inductive receiving coils in parallel with a distinct capacitor so that each of the inductive receiving coil and distinct capacitor pairs also have said first resonant frequency as their calculated resonant frequency, and the step of driving said at least one inductive transmit coil near, but not at, said first resonant frequency.

17. The method of claim 12, wherein said method further includes the step of ignoring touch input from a user's body if a touch area exceeds a predetermined minimum area.

18. The method of claim 12, wherein said method further includes detection of a user gesture via said charge transfer measurement circuitry, said gesture used to reposition a displayed cursor within an associated displayed space, and wherein said gesture comprises the steps of pressing with the stylus on said trackpad, subsequently contacting the trackpad with at least one finger, repositioning said cursor through finger movement on the trackpad and moving said finger away from the trackpad to lock or set the cursor position within said displayed space.

19. The method of claim 12, wherein said method further includes detection of a user stylus gesture via said charge transfer measurement circuitry, said gesture used to reposition a displayed cursor within an associated displayed space, and where said gesture comprises the steps of pressing said stylus against the trackpad, depressing a second switch of the stylus, and changing the stylus position on said trackpad while keeping said second switch depressed to cause a proportional change in the position of the displayed cursor.

20. The method of claim 12, wherein said trackpad further comprises a secondary display which replicates selected content displayed on an associated primary display, and wherein said user input via proximity or touch is used to reposition said selected content and said user input via stylus is used to enter additional content amongst said selected content.
